(19) United States
(12) Patent Application Publication
(10) Pub. No.: US 2023/0032860 A1
(43) Pub. Date: Feb. 2, 2023

(54) IMAGE PROCESSING APPARATUS AND METHOD AND NON-TRANSITORY COMPUTER READABLE MEDIUM

(71) Applicant: FUJIFILM Business Innovation Corp., Tokyo (JP)

(72) Inventor: Aoi KAMO, Kanagawa (JP)

(73) Assignee: FUJIFILM Business Innovation Corp., Tokyo (JP)

(21) Appl. No.: 17/697,929

(22) Filed: Mar. 18, 2022

(30) Foreign Application Priority Data
Jul. 29, 2021 (JP) 2021-124785

(51) Int. Cl. G06T 11/60; G06V 10/46; G06T 3/40

(52) U.S. Cl. CPC G06T 11/60; G06V 10/462; G06T 3/40; G06T 2210/22

(57) ABSTRACT

An image processing apparatus includes a processor configured to: display an image on a display device; calculate, for each of small regions set in the image, a degree of importance based on characteristics of the image; and display a degree-of-importance map on the display device in such a manner that the degree-of-importance map is superimposed on a subject region of the image, the degree-of-importance map visually representing a relative relationship between the degrees of importance of the small regions.

### CROSS-REFERENCE TO RELATED APPLICATIONS

This application is based on and claims priority under 35 USC 119 from Japanese Patent Application No. 2021-124785 filed Jul. 29, 2021.

### BACKGROUND

### (i) Technical Field

The present disclosure relates to an image processing apparatus and method and a non-transitory computer readable medium.

### (ii) Related Art

Various image processing operations using a computer can be executed. Placing of an image or text on a background image and cropping of an image using a specific frame are examples of such image processing using a computer.

Japanese Patent No. 5224149 discloses the following image processing method. A composition pattern for an input image is set based on the number of regions of interest in the input image and the scene of the input image. A region to be cropped is determined so that a first energy function represented by the distance between the center position of a rectangular region of interest and the center position of the region to be cropped becomes a greater value and so that a second energy function represented by the area of the region to be cropped which extends to outside the input image becomes a smaller value.

Japanese Unexamined Patent Application Publication No. 2019-46382 discloses the following image processing method. An object placeable region where an image object can be placed within a print region to be printed on a print medium and an image object to be placed in the object placeable region are selected. Then, a specific color used for the selected image object is set for a background color of a space region, which is different from the object placeable region in the print region.

### SUMMARY

Image processing, such as placing of an image and cropping of an image, is executed based on various rules and plans set in accordance with the content of processing. To execute various contents of image processing, it is necessary to set rules and plans in accordance with each content of image processing. This involves complicated operations.

Aspects of non-limiting embodiments of the present disclosure relate to making processing for placing an object on an image less complicated, compared with when image processing is executed based on various rules and plans set in accordance with the content of processing.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing apparatus including a processor configured to: display an image on a display device; calculate, for each of small regions set in the image, a degree of importance based on characteristics of the image; and display a degree-of-importance map on the display device in such a manner that the degree-of-importance map is superimposed on a subject region of the image, the degree-of-importance map visually representing a relative relationship between the degrees of importance of the small regions.

### BRIEF DESCRIPTION OF THE DRAWINGS

An exemplary embodiment of the present disclosure will be described in detail based on the following figures, wherein:

FIG. 1 is a block diagram illustrating the configuration of an image processing apparatus to which the exemplary embodiment is applied;

FIG. 2 is a block diagram illustrating the hardware configuration of the image processing apparatus;

FIGS. 3A through 3C illustrate the application of the exemplary embodiment to trimming of an image and show an example of the image cropped by trimming;

FIGS. 4A through 4C illustrate other examples of images cropped by trimming;

FIGS. 5A through 5C illustrate an approach to generating a top-down saliency map;

FIGS. 6A and 6B illustrate an approach to creating a bottom-up saliency map;

FIG. 7A illustrates a top-down saliency map and a degree-of-importance map created from the top-down saliency map;

FIG. 7B illustrates a bottom-up saliency map and a degree-of-importance map created from the bottom-up saliency map;

FIG. 8 illustrates an example of an integrated degree-of-importance map;

FIGS. 9A and 9B illustrate an example of the placement of a trimming frame;

FIGS. 10A and 10B illustrate an example of the placement of a trimming frame provided with a weighting factor;

FIG. 11A illustrates a trimming result without the use of a weighting factor for a trimming frame;

FIG. 11B illustrates a trimming result with the use of a weighting factor for a trimming frame;

FIG. 12A illustrates an example of a saliency map based on a background image;

FIG. 12B illustrates an example of a saliency map set for a placement region of an image object;

FIG. 12C illustrates an example of a weighting factor set for the image object;

FIG. 13A illustrates the saliency map shown in FIG. 12A and a degree-of-importance map created from this saliency map;

FIG. 13B illustrates the saliency map shown in FIG. 12B and a degree-of-importance map created from this saliency map;

FIG. 14 illustrates an example of an integrated degree-of-importance map;

FIGS. 15A through 15C illustrate an example of the placement of an image object;

FIGS. 16A through 16C illustrate an example in which a composite image is created by placing an image object on a background image;

FIGS. 17A and 17B illustrate an example of changing of the size of an object;

FIGS. 18A and 18B illustrate an example of rotating of an object;

FIGS. 19A through 19C illustrate a placement example of discrete objects;

FIGS. 20A and 20B illustrate an example of transformation of an object;

FIGS. 21A through 21C illustrate the relationship of the placement position of an object to the weighting factor set for a degree-of-importance map of a background image and that set for a degree-of-importance map of a region setting frame;

FIGS. 22A through 22F illustrate an example in which multiple objects are sequentially placed on a background image;

FIG. 23 illustrates an example of the composition of an image specified based on a degree-of-importance map;

FIGS. 24A and 24B illustrate an approach to creating video images by moving a trimming frame along a flow path on a degree-of-importance map;

FIGS. 25A through 25C illustrate an approach to creating video images by moving an image object along a flow path on a degree-of-importance map;

FIGS. 26A through 26C illustrate examples of the shape of a region setting frame;

FIG. 27 illustrates a display example of a degree-of-importance map;

FIGS. 28A and 28B illustrate examples of an image on which an object including text is placed;

FIG. 29 illustrates an example of a template region;

FIG. 30 illustrates the relationship of a combination of images and display frames in a template region to the total value of maximum inter-frame degrees of importance;

FIGS. 31A through 31D illustrate a combination of display frames and images in which the total value of maximum inter-frame degrees of importance becomes the largest; and

FIG. 32 illustrates the relationship of a combination of images and display frames in a template region to the total value of maximum inter-frame degrees of importance when the number of display frames is greater than that of images.

### DETAILED DESCRIPTION

An exemplary embodiment of the disclosure will be described below in detail with reference to the accompanying drawings.

### [Functional Configuration of Image Processing Apparatus]

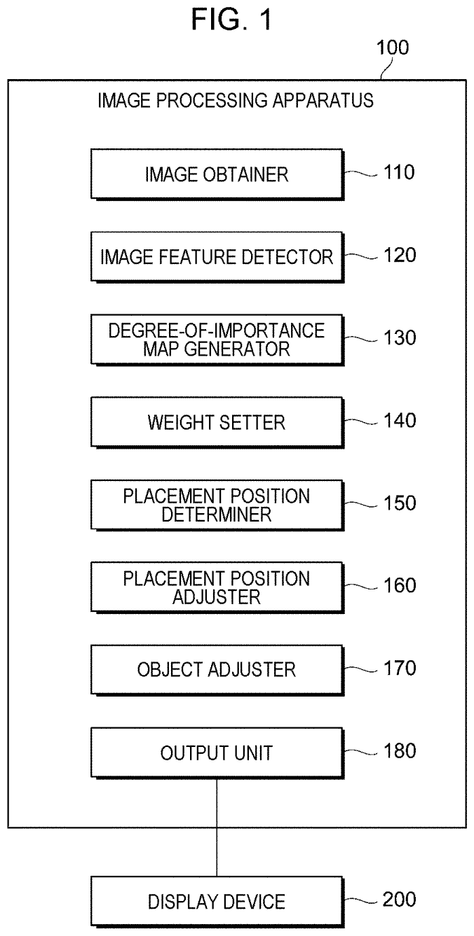

FIG. 1 is a block diagram illustrating the configuration of an image processing apparatus 100 to which the exemplary embodiment is applied. The image processing apparatus 100 includes an image obtainer 110, an image feature detector 120, a degree-of-importance map generator 130, a weight setter 140, a placement position determiner 150, a placement position adjuster 160, an object adjuster 170, and an output unit 180. A display device 200 is connected to the image processing apparatus 100. An image output from the output unit 180 of the image processing apparatus 100 is displayed on the display device 200.

The image processing apparatus 100 executes image processing including the placement of an object on an image. Various objects can be placed on an image in accordance with the content of image processing. For example, an image object may be superimposed on a background image. A frame for specifying a region of an image to be trimmed (hereinafter, such a frame will be called a trimming frame) may be placed on the image. As the display device 200, a liquid crystal display, for example, may be used.

The image obtainer 110 serves as a function unit that obtains an image to be processed. An image is obtained by reading image data to be processed from a storage or by reading an image formed on a sheet with a scanner, for example. Plural images may be processed depending on the content of image processing. For example, to place an image object on a background image, both of the background image and the image object are images to be processed. In this case, the image obtainer 110 obtains the background image and the image object. When a specific subject in a certain image is used as an image object, the image obtainer 110 may first detect the outline of this specific subject, trim the subject along the detected outline, and then use the trimmed subject as an image object. After an object is placed on an image by using the functions of the image processing apparatus 100 (such functions will be discussed below), the image obtainer 110 may obtain this image as an image to be processed.

The image feature detector 120 serves as a function unit that detects a feature (characteristics) of an image to be processed. The feature of an image is specified based on the characteristics of each small region set in the image. Various factors may be used to represent the characteristics of each small region of an image. In the exemplary embodiment, visual saliency is used as the characteristics of each small region. There are two types of visual saliency: top-down saliency and bottom-up saliency. The top-down saliency expresses the degree of attention based on human memory and experience. For example, the top-down saliency is high for a face or a figure in an image. The bottom-up saliency expresses the degree of attention based on human perception properties. For example, the bottom-up saliency is high for the outline of an object and a portion of an image where the color or brightness significantly changes. The size and the shape of a small region of an image are not limited to a particular size and a particular shape. As the size of a small region is smaller, the precision of processing using the degree of importance, which will be discussed later, is improved. Hence, an individual pixel, for example, may be used as the unit of a small region.

The image feature detector 120 calculates the top-down saliency and the bottom-up saliency for each small region from an image to be processed, and creates a saliency map for the entirety of a region to be processed in the image (hereinafter, such a region will be called a target region). The target region is a region of a background image where an object can be placed. The saliency map is a map representing a distribution of the saliency levels of the individual small regions in the target region. As the saliency map, the image feature detector 120 creates a saliency map representing the top-down saliency of the entire target region (hereinafter called a top-down saliency map) and a saliency map representing the bottom-up saliency of the entire target region (hereinafter called a bottom-up saliency map). Depending on the relationship with processing executed by the degree-of-importance map generator 130, the image feature detector 120 creates a saliency map by integrating a top-down saliency map and a bottom-up saliency map (hereinafter, such a saliency map will be called an integrated saliency map). Details of various saliency maps will be discussed later.

The degree-of-importance map generator 130 serves as a function unit that creates a degree-of-importance map for a target region of an image, based on saliency maps created by the image feature detector 120. The degree-of-importance map is a map representing a distribution of the degrees of importance calculated for individual small regions. The degree of importance is an element which contributes to giving a specific tendency to the placement of an object.

The degree of importance is determined for each small region of a target region of an image by reflecting the saliency of another small region of the image. In a specific example, a certain small region of a target region is set to be a small region of interest, and the degree of importance of this small region of interest is calculated based on the saliency of each of the other small regions of the target region. In a more detailed example, the degree of importance of the small region of interest is calculated as follows. As the distance from the small region of interest to another small region is smaller, the influence of the saliency of this small region on the small region of interest becomes greater, while, as the distance from the small region of interest to another small region is larger, the influence of the saliency of this small region on the small region of interest becomes smaller. With this calculation approach, as a whole, the degree of importance becomes high in a region where the saliency of an image is high, while the degree of importance becomes low in a region where the saliency of the image is low. Even in a region where the value of saliency is flat, the degree of importance varies among individual small regions depending on the distance of a small region to a surrounding region where saliency is high. Calculation of the degree of importance will be discussed later.

The degree-of-importance map generator 130 visualizes the created degree-of-importance map and superimposes it on an image. In the visualized degree-of-importance map, for example, the positional relationship between small regions whose degree of importance is the same or whose difference in the degree of importance is smaller than a certain difference range is visually expressed. In the visualized degree-of-importance map, for example, a region having a higher degree of importance than a surrounding region and a region having a lower degree of importance than a surrounding region are expressed such that they can be visually identified. As the approach to visualizing (expressing) a degree-of-importance map, various existing methods for visually representing a spatial characteristic distribution may be used. For example, as in contour lines, values of the degree of importance may be divided into some groups in certain increments, and small regions in the same group may be indicated by the same curved line. In another example, as in a temperature distribution map, small regions may be expressed by different colors or grayscale in accordance with the values of the degrees of importance.

The degree-of-importance map generator 130 creates a degree-of-importance map based on information integrating the top-down saliency and the bottom-up saliency. As a procedure for integrating the top-down saliency and the bottom-up saliency, the degree-of-importance map generator 130 may first combine a top-down saliency map and a bottom-up saliency map with each other to create an integrated saliency map and then create a degree-of-importance map based on the integrated saliency map. Alternatively, the degree-of-importance map generator 130 may create a degree-of-importance map based on the top-down saliency map and also create another degree-of-importance map based on the bottom-up saliency map and then combine the two degree-of-importance maps with each other. Details of the procedure for integrating the top-down saliency and the bottom-up saliency will be discussed later.

The weight setter 140 serves as a function unit that sets a weighting factor to be applied to the value of the degree of importance of each small region in the degree-of-importance map. The weighting factor is set to change the value of the degree of importance of an image (background image) on which an object is superimposed. The weighting factor is set for each small region of an object (small regions of the object are set similarly to small regions of an image). Then, the value of the degree of importance of a small region of the image located at a position of a corresponding small region of the object when the object is superimposed on the image is multiplied by the value of the weighting factor set for this small region of the object. As a result, the degree of importance of the image on which the object is superimposed is changed.

The approach to setting the weighting factor and the value of the weighting factor differ depending on the type of image processing. For example, if the content of processing concerns placing of an image object on a background image, the value of the weighting factor (hereinafter called the weighting value) is set in accordance with the content of the image object. In one example, if the image object includes a highly transparent portion, a small weighting value is set for this portion. If the image object is highly transparent, it means that the background image on which the image object is placed can be seen through the image object. As a result of setting a small weighting value to a highly transparent portion of an image object, in searching for the placement position of the image object, the influence of the degree of importance of a portion in a background image corresponding to the highly transparent portion of the image object can be reduced.

If the content of processing concerns placing of a trimming frame as an object on an image, the weighting value is set for a region inside the trimming frame in accordance with the composition of the image to be cropped by trimming. In one example, if the composition of the image after trimming is determined such that a target person or object is placed at the center of the image, a larger weighting value is set for the center of the region inside the trimming frame, while a smaller weighting value is set for a more peripheral portion of the region inside the trimming frame, so that the degree of importance at and around the center of the image to be cropped by trimming becomes high. Setting of the weighting value in accordance with the composition of an image to be cropped by trimming may be performed in response to an instruction from a user, for example. This can reflect the intention of the user concerning the composition of the image.

The placement position determiner 150 is a function unit that searches for and determines the placement position of an object to be placed on an image, based on the degree-of-importance map of the image. The placement position of an object determined by the placement position determiner 150 differs depending on the type of image processing, in other words, the type of object to be placed on the image. The placement position determiner 150 determines the placement position of the object so that the total value of the degrees of importance of small regions of a background image on which the image object is placed satisfies a predetermined condition.

For example, if the type of processing concerns placing of an image object on a background image, the placement position determiner 150 may determine the placement position of the image object so that the image object can be placed in a region where the degree of importance in the degree-of-importance map is low. In a more specific example, the placement position determiner 150 may place the image object at a position where the total value of the degrees of importance in the small regions of the background image on which the image object is placed becomes the smallest value.

If the type of processing concerns placing of a trimming frame as an object on an image, the placement position determiner 150 may determine the placement position of the trimming frame so that the trimming frame can be placed in a region where the degree of importance in the degree-of-importance map is high. In a more specific example, the placement position determiner 150 may place the trimming frame at a position where the total value of the degrees of importance in the small regions of the image on which the trimming frame is placed becomes the largest value.

If the type of processing concerns placing of an object which can be transformed and placed on an image, the placement position determiner 150 may first process the object and determine the placement position so that the size of the object can be maximized in a region where the degree of importance of a background image is smaller than or equal to a specific value. The specific value of the degree of importance, which is used as a reference value, may be determined in accordance with a preset rule or may be specified in response to an instruction from a user. The object may be processed with a certain limitation. Regarding the transformation of an object, for example, only the size of the object may be changed while the similarity of the figure of the original object is maintained. In another example, if a polygon object is processed, only the lengths of sides of the polygon object may be changed or the lengths of sides and the angle of the polygon object may be changed.

The placement position adjuster 160 serves as a function unit that adjusts the placement position of an object determined by the placement position determiner 150. Examples of the adjustment of the placement position of an object performed by the placement position adjuster 160 are rotating of the object and shifting of the object.

Regarding the rotating of an object, after the object is placed by the placement position determiner 150, the placement position adjuster 160 may rotate the object about a specific point of the object, for example. The placement angle of the object may be adjusted so that the total value of the degrees of importance of the small regions on which the object is placed becomes the smallest value, for example. As the center of rotation of the object, the center of gravity of the object may be used, or if the object is a quadrilateral, a specific vertex (vertex on the top left corner, for example) of the object may be used. A user may specify the center of rotation.

Regarding the shifting of an object, the placement position adjuster 160 may set the initial position of the object in the image, the target position of the object in the image, and a flow path from the initial position to the target position, and then dynamically change a specific point of the object from the initial position to the target position along the flow path. As the specific point, which serves as a reference point for shifting the object, the center of gravity of the object may be used, or if the object is a quadrilateral, a specific vertex (vertex on the top left corner, for example) of the object may be used. A user may specify this point.

The initial position may be specified by a user, for example. The target position may be set at a position where the total value of the degrees of importance of the small regions on which the object is placed becomes the smallest value. The flow path may be set based on a slope of the degree of importance represented by a degree-of-importance map, in which case, the flow path may be set as a path along the smallest slope or the largest slope. The slope of the degree of importance is expressed by the ratio of the difference in the value of the degree of importance between two points in the degree-of-importance map to the distance between these two points.

The object adjuster 170 serves as a function unit that adjusts the characteristics of an object. Examples of the characteristics of an object to be adjusted by the object adjuster 170 are the size, shape, and color of the object.

Regarding the adjustment of the size of an object, the object adjuster 170 may adjust the size of the object so that the area of the object can be maximized in a region where the degree of importance of a background image is smaller than or equal to a specific value. If the object to be placed on a background image is an object that can be transformed, the placement position determiner 150 may change the size of the object and place it on the background image. In this case, there is no need for the object adjuster 170 to adjust the object. The object adjuster 170 adjusts the size of the object when the object needs to be enlarged or reduced after being placed by the placement position determiner 150, for example.

Regarding the adjustment of the shape of an object, the object adjuster 170 may adjust the shape of the object so that the area of the object can be maximized in a region where the degree of importance of a background image is smaller than or equal to a specific value. The shape of the object may be changed with a certain limitation. For example, if a polygon object is used, only the lengths of sides of the polygon object may be changed or the lengths of sides and the angle of the polygon object may be changed. In another example, the shape of a polygon object may be changed so that all vertices or some specific vertices of the polygon object are superimposed on small regions of a background image where the degree of importance is a specific value.

Regarding the adjustment of the color of an object, for the object whose placement position is determined by the placement position determiner 150, the object adjuster 170 determines the color of the object, based on a predetermined rule, by reflecting image information on a portion around the object and/or the overall color balance. The object adjuster 170 may adjust, not only the color of the object, but also the brightness and the contrast, by taking a factor such as the balance with image information on a portion around the object into account.

The output unit 180 outputs an image on which an object is placed and causes the display device 200 to display the image. The output unit 180 may cause the display device 200 to display an image on which a visualized degree-of-importance map is superimposed. If the distribution of the degrees of importance in the visualized degree-of-importance map is expressed by different colors or grayscale, a suitable level of transparency is given to the degree-of-importance map so as to allow a user to recognize the distribution of the degrees of importance while looking at the image through the degree-of-importance map.

### [Hardware Configuration]

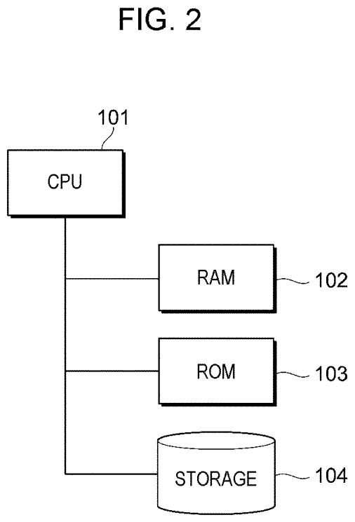

FIG. 2 is a block diagram illustrating the hardware configuration of the image processing apparatus 100. The image processing apparatus 100 is implemented by a computer. The computer forming the image processing apparatus 100 includes a central processing unit (CPU) 101, a random access memory (RAM) 102, a read only memory (ROM) 103, and a storage 104. The CPU 101 is a processor. The RAM 102, the ROM 103, and the storage 104 are memory devices. The RAM 102 is a main memory and is used as a work memory for the CPU 101 to execute arithmetic processing. In the ROM 103, a program and data, such as preset values, are stored. The CPU 101 can read the program and data directly from the ROM 103 and execute processing. The storage 104 stores a program and data. The CPU 101 reads the program stored in the storage 104 into the main memory and executes the program. In the storage 104, the results of processing executed by the CPU 101 are also stored. As the storage 104, a magnetic disk or a solid state drive (SSD), for example, is used.

If the image processing apparatus 100 is implemented by the computer shown in FIG. 2, the functions of the image processing apparatus 100, that is, the image obtainer 110, the image feature detector 120, the degree-of-importance map generator 130, the weight setter 140, the placement position determiner 150, the placement position adjuster 160, the object adjuster 170, and the output unit 180, are implemented by the program-controlled CPU 101, for example.

Additionally, the computer forming the image processing apparatus 100 has various input/output interfaces and a communication interface and is connectable to input devices, such as a keyboard and a mouse, and output devices, such as a display device, and external devices, though such interfaces and devices are not shown. With this configuration, the image processing apparatus 100 is able to receive data to be processed and an instruction from a user and to output an image indicating a processing result to the display device.

### [Operation of Image Processing Apparatus]

Processing for generating a degree-of-importance map and placing an object using the degree-of-importance map executed by the image processing apparatus 100 of the exemplary embodiment will be described below through illustration of specific examples. In the following examples, processing for placing a trimming frame as an object and processing for placing an image object on a background image will be discussed below.

### (Placement of Trimming Frame)

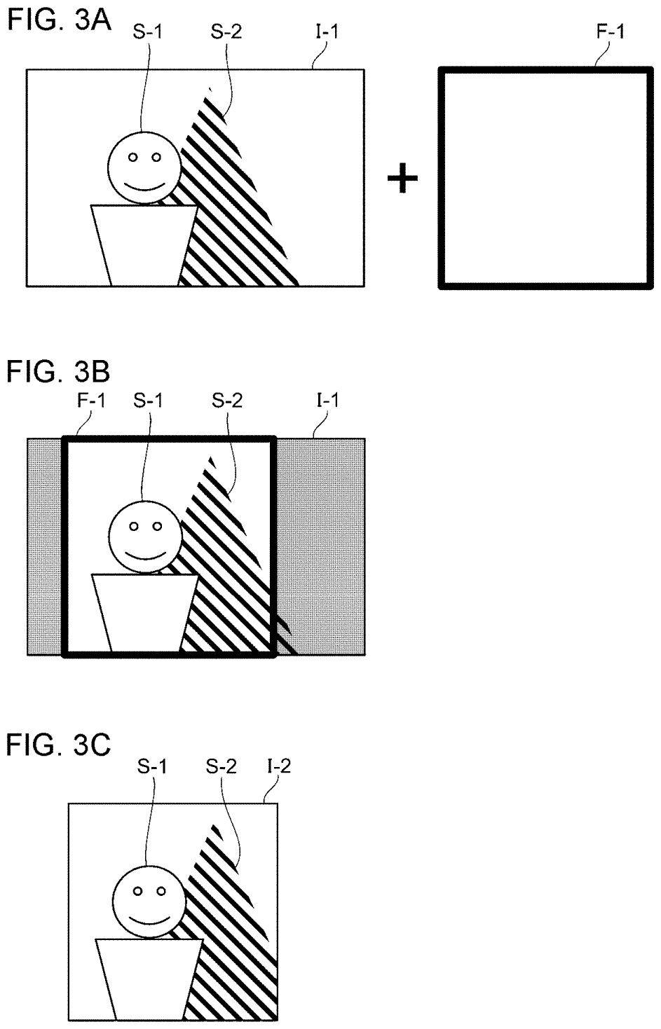

FIGS. 3A through 3C illustrate the application of the exemplary embodiment to trimming of an image. FIG. 3A illustrates an example of an image to be processed and an example of a trimming frame. FIG. 3B illustrates a state in which the image and the trimming frame shown in FIG. 3A are superimposed on each other. FIG. 3C illustrates a state in which the image is cropped along the trimming frame shown in FIG. 3B.

In the exemplary embodiment, in trimming of an image, the image processing apparatus 100 first obtains an image to be processed (hereinafter called a target image) and also sets a trimming frame. As a trimming frame, a trimming frame specified by a user may be set or a trimming frame based on a predetermined setting may be set. In the example in FIG. 3A, a landscape-oriented rectangular target image I-1 is obtained, and a substantially square trimming frame F-1 is set. Around the center of the target image I-1, a subject S-1 of a person is drawn around the center and a triangular subject S-2, such as a tree or a tower, is drawn behind the subject S-1 such that the subject S-2 overlaps the subject S-1. Given that the subject S-1 is drawn in front of the subject S-2, it can be assumed that the subject S-1 is a main subject and the subject S-2 is a background subject in the target image I-1. It is also assumed that the region other than the main subject and the background subject in the target image I-1 is a blank region. Although, in the example in FIGS. 3A through 3C, one main subject and one background subject are drawn in the target image I-1, a target image may include plural main subjects and/or plural background subjects.

The image processing apparatus 100 then generates a degree-of-importance map of the target image I-1 and places the trimming frame F-1 on the target image I-1, based on the generated degree-of-importance map. In the example in FIG. 3B, the subject S-1 is entirely contained in the trimming frame F-1 with a slight margin left on the left side, while most of the subject S-2 is contained in the trimming frame F-1 with part of the right side of the subject S-2 missing. A specific approach to calculating the saliency and the degree of importance will be discussed later. In the exemplary embodiment, the degree of importance of the main subject is the highest, that of the background subject is the second highest, and that of the blank region is the lowest. Based on the distribution of the degrees of importance, a trimming frame is automatically placed on a target image so that a well-balanced screen is generated.

When the trimming frame F-1 is placed on the target image I-1, the image processing apparatus 100 crops the target image I-1 along the trimming frame F-1 and obtains a processed image I-2. In the example in FIG. 3C, the region of the target image I-1 included in the trimming frame F-1 in FIG. 3B is cropped to result in the processed image I-2. In the processed image I-2, the entirety of the subject S-1, which is the main subject, is drawn, while the subject S-2, which is the background subject, occupies a considerable amount of the area of the image I-2 though part of the subject S-2 is missing. As a result, a well-balanced screen (composition) is generated so that a user can recognize that the subject S-1 is a main theme and the subject S-2 is a sub-theme.

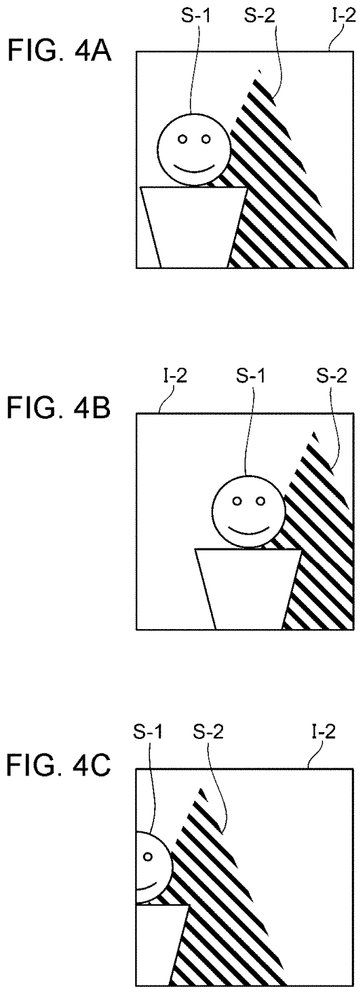

FIGS. 4A through 4C illustrate other examples of images cropped by trimming. FIG. 4A illustrates that the image is cropped so that both of the two subjects are contained in the screen. FIG. 4B illustrates that the image is cropped so that the main subject is placed substantially at the center of the screen. FIG. 4C illustrates that the image is cropped so that the background subject is placed around the center of the screen.

In the example in FIG. 4A, although both of the subjects S-1 and S-2 are entirely included in the screen, the subject S-1 is too close to the left edge of the screen with almost no margin left on the left side. It is thus not clear which one of the subjects S-1 and S-2 is a main theme and the other one is a sub-theme, thereby resulting in an unbalanced screen.

In the example in FIG. 4B, the subject S-1 is placed substantially at the center of the screen and can be recognized as a main theme of the image I-2. However, the right side of the subject S-2 significantly extends to outside the screen, while a large margin is left on the left of the subject S-1, thereby resulting in an unbalanced screen.

In the example in FIG. 4C, the left side of the subject S-1 significantly extends to outside the screen, while the subject S-2 is placed around the center of the screen. This gives the impression that the subject S-2, which is a background subject, is a main theme, thereby resulting in an extremely unbalanced screen.

Calculating of the saliency and the degree of importance for placing the trimming frame F-1 on the target image I-1 will now be discussed below. In the exemplary embodiment, the saliency is calculated for each small region set in the target image I-1, and a saliency map is generated for the entirety of the target image I-1 based on the calculated saliency for each small region. There are two types of saliency for each small region: top-down saliency and bottom-up saliency. As the saliency map, a top-down saliency map based on the top-down saliency and a bottom-up saliency map based on the bottom-up saliency are created. Then, based on the created saliency maps, a degree-of-importance map for the entirety of the target image I-1 is generated.

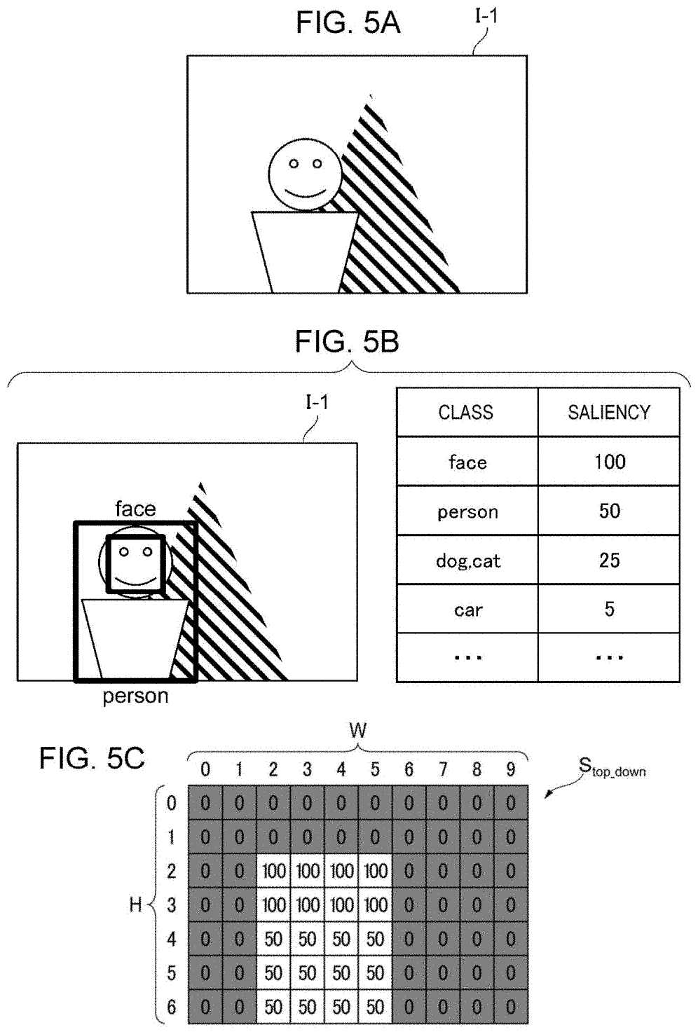

FIGS. 5A through 5C illustrate an approach to generating a top-down saliency map. FIG. 5A illustrates an example of the target image I-1. FIG. 5B illustrates examples of set values of the top-down saliency. FIG. 5C illustrates an example of a top-down saliency map. It is assumed that the target image I-1 shown in FIG. 5A is the same as that in FIG. 3A.

Regarding the top-down saliency, a higher value is given to a subject and a part of the subject having a higher degree of attention based on human memory and experience. Specific values of the top-down saliency to be given to individual subjects and parts are determined in advance and are formed into a database, for example, and the database is stored in the storage 104 in FIG. 2, for example. In the example in FIG. 5B, the top-down saliency values (written as “saliency” in FIG. 5B) are set for “face”, “person”, “dog, cat”, “car”, etc. FIG. 5B also shows that, as a subject and a part that are likely to have saliency, “face” and “person” are detected from the target image I-1.

In the exemplary embodiment, a top-down saliency map is generated as a result of giving a top-down saliency value to each small region of the target image I-1 in accordance with the display content of the small region. When a subject or a part that is likely to have saliency is detected, such as when “face” and “person” are detected as shown in FIG. 5B, the top-down saliency values set for “face” and “person” are given to the small regions where “face” and “person” are displayed in the top-down saliency map.

FIG. 5C illustrates an example of a top-down saliency map S_{top_down} in which 70 small regions (W×H=10×7=70) are set in the target image I-1, where W is the number of small regions in the horizontal direction (hereinafter called the X direction) of the target image I-1 and H is the number of small regions in the vertical direction (hereinafter called the Y direction) of the target image I-1. In the top-down saliency map S_{top_down}, coordinate values of 0 to 9 are given from the left to the right in the X direction, while coordinate values of 0 to 6 are given from the top to the bottom in the Y direction. The coordinates of the small region at the top left corner is (x, y)=(0, 0) and those at the bottom right corner is (x, y)=(9, 6), where “x” is the coordinate value in the X direction and “y” is the coordinate value in the Y direction.

In the top-down saliency map S_{top_down} shown in FIG. 5C, eight small regions at (x, y)=(2 to 5, 2 to 3) are those corresponding to the positions at which “face” shown in FIG. 5B is detected, and the value “100” of the top-down saliency is given to these small regions. Twelve small regions at (x, y)=(2 to 5, 4 to 6) are those corresponding to the positions at which “person” shown in FIG. 5B is detected, and the value “50” of the top-down saliency is given to these small regions. For the sake of representation, in the example in FIG. 5C, the small regions are set for the target image I-1 in rough increments. In actuality, the small regions are set in finer increments, such as using pixels, and a top-down saliency map S_{top_down} can reproduce the shape of a subject more accurately.

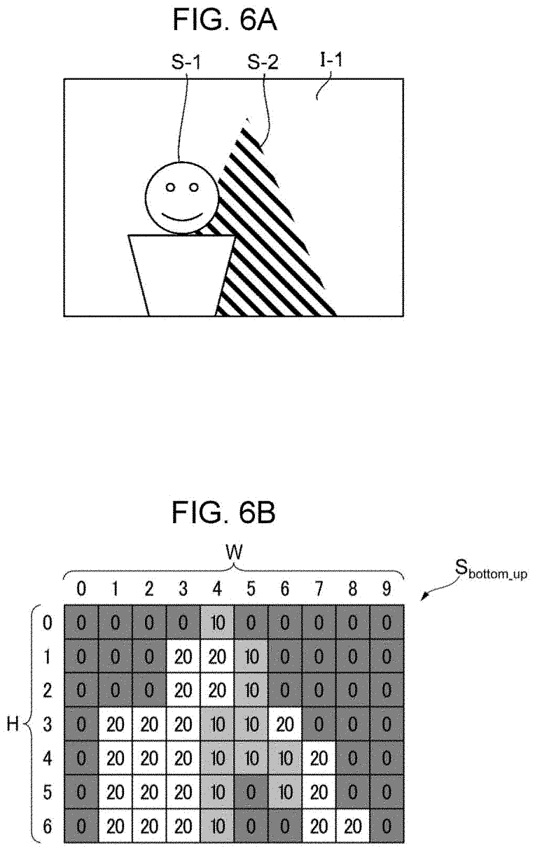

FIGS. 6A and 6B illustrate an approach to creating a bottom-up saliency map. FIG. 6A illustrates an example of a target image I-1. FIG. 6B illustrates an example of a bottom-up saliency map. It is assumed that the target image I-1 shown in FIG. 6A is the same as that in FIG. 3A. As in the top-down saliency map S_{top_down} shown in FIG. 5C, a bottom-up saliency map S_{bottom_up} shown in FIG. 6B is created in which 70 small regions (W×H=10×7=70) are set in the target image I-1, where W is the number of small regions in the X direction of the target image I-1 and H is the number of small regions in the Y direction of the target image I-1.

Regarding the bottom-up saliency, a higher value is given to a portion of an image where the color or brightness significantly changes, such as an outline of a subject. In the example in FIG. 6B, a high value (“20” in the example in FIG. 6B) is given to portions at and near the boundary between the subject S-1 and the blank region, portions at and near the boundary between the subject S-2 and the blank region, and portions at and near the boundary between the subject S-1 and the subject S-2, while a low value (“10” in the example in FIG. 6B) is given to regions near these portions. The bottom-up saliency values for small regions ((x, y)=(5, 5), (5, 6), and (6, 6)) inside the subject S-2 where no considerable visual change is observed and the blank regions separated from the subjects S-1 and S-2 are “0”.

Then, a degree-of-importance map of the target image I-1 is generated based on the saliency maps discussed with reference to FIGS. 5A through 6B. As stated above, two types of saliency maps, that is, a top-down saliency map and a bottom-up saliency map, are created. Accordingly, before a degree-of-importance map is generated from these two saliency maps, information based on the top-down saliency and information based on the bottom-up saliency are integrated with each other. As one specific procedure of integrating these two items of information, a degree-of-importance map based on the top-down saliency map and another degree-of-importance map based on the bottom-up saliency map may be created, and then, these degree-of-importance maps may be integrated with each other. As another specific procedure of integrating these two items of information, the top-down saliency map and the bottom-up saliency map may be integrated with each other, and then, a degree-of-importance map may be generated based on the integrated saliency map. In the following example, the first procedure is employed to create a degree-of-importance map.

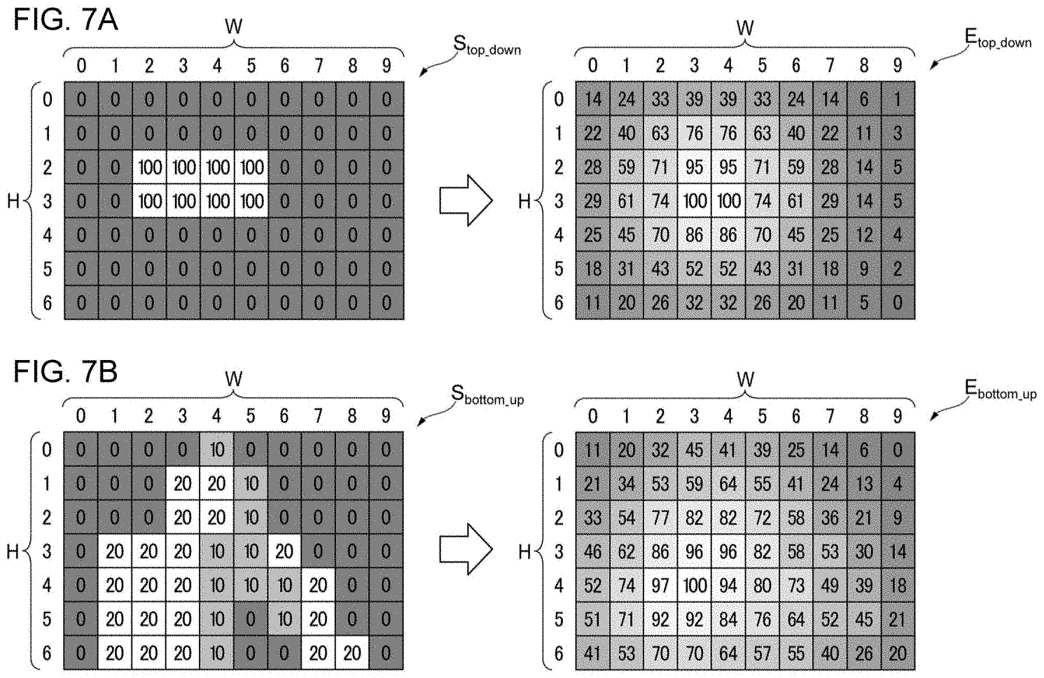

FIGS. 7A and 7B illustrate degree-of-importance maps created from saliency maps. FIG. 7A illustrates a top-down saliency map and a degree-of-importance map based on the top-down saliency map. FIG. 7B illustrates a bottom-up saliency map and a degree-of-importance map based on the bottom-up saliency map. In FIG. 7A, the top-down saliency map S_{top_down} is shown at the tail of the arrow, while the degree-of-importance map based on the top-down saliency map S_{top_down} (hereinafter called the top-down degree-of-importance map E_{top_down}) is shown at the head of the arrow. In FIG. 7B, the bottom-up saliency map S_{bottom_up} is shown at the tail of the arrow, while the degree-of-importance map based on the bottom-up saliency map S_{bottom_up} (hereinafter called the bottom-up degree-of-importance map E_{bottom_up}) is shown at the head of the arrow. In the following description, if the top-down type and the bottom-up type are not distinguished from each other, the top-down saliency map S_{top_down} and the bottom-up saliency map S_{bottom_up} will collectively be called the saliency map S, and the top-down degree-of-importance map E_{top_down} and the bottom-up degree-of-importance map E_{bottom_up} will collectively be called the degree-of-importance map E. The saliency and the degree of importance of each small region will be called the saliency S(x, y) and the degree of importance E(x, y), respectively, appended with the coordinate values.

Among the individual small regions set in the target image I-1, one small region is focused and is set to be a small region of interest. Small regions other than the small region of interest are set to be reference small regions. The coordinate value x of each small region of the target image I-1 in the X direction is set to be 0 to W-1, while the coordinate value y in the Y direction is set to be 0 to H-1. The coordinates of the small region of interest are indicated by (x, y), and the coordinates of each reference value are indicated by (i, j). It is noted that i≠x and j≠y.

The degree of importance E(x, y) of the small region of interest (x, y) is defined by the sum of the degrees of spatial influence of the saliency S(i, j) of the individual reference small regions (i, j) on the small region of interest (x, y). This degree of spatial influence is defined by a function that sequentially attenuates the influence in accordance with the spatial distance from the small region of interest (x, y) to a reference small region (i, j). As an example of the function representing the degree of spatial influence, the function D_{x,y}(i, j), which is inversely proportional to the distance, expressed by the following equation (1) is used.

$${D}_{x , y} ( i , j ) = \frac{1}{\sqrt{{( x - i )}^{2} + {( y - j )}^{2}}} \qquad ( 1 )$$

The top-down degree of importance E_{top_down} (x, y) of the small region of interest is expressed by the following equation (2), while the bottom-up degree of importance E_{bottom_up} (x, y) of the small region of interest is expressed by the following equation (3).

$${E}_{top \_ down} ( x , y ) = {\sum }_{i = 0}^{W - 1} {\sum }_{j = 0}^{H - 1} {S}_{top \_ down} ( i , j ) {D}_{x , y} ( i , j ) \qquad ( 2 )$$

$${E}_{bottom \_ up} ( x , y ) = {\sum }_{i = 0}^{W - 1} {\sum }_{j = 0}^{H - 1} {S}_{bottom \_ up} ( i , j ) {D}_{x , y} ( i , j ) \qquad ( 3 )$$

Since the top-down degree-of-importance map E_{top_down} and the bottom-up degree-of-importance map E_{bottom_up} are combined with each other, which will be discussed later, the value of the top-down degree of importance and that of the bottom-up degree of importance are normalized by the following equation (4):

$${E}^{′ ( x , y )} = \frac{a - b}{max ( E ) - min ( E )} ( E ( x , y ) - min ( E ) ) \qquad ( 4 )$$

where a is the maximum normalized value, b is the minimum normalized value, max(E) is the maximum value of the degrees of importance of the individual small regions calculated in equation (2) or equation (3), and min(E) is the minimum value of the degrees of importance of the individual small regions calculated in equation (2) or equation (3).

Then, the top-down degree-of-importance map E_{top_down} and the bottom-up degree-of-importance map E_{bottom_up} are integrated with each other, thereby resulting in an integrated degree-of-importance map Eₜₒₜₐₗ. The integrated value of the degree of importance of each small region is calculated by the following equation (5).

Eₜₒₜₐₗ=αE_{top-down}+(1−α)E_{bottom-up} (5)

In equation (5), a is set to be a suitable value, and then, the level of influence of the top-down degree-of-importance map E_{top_down} and that of the bottom-up degree-of-importance map E_{bottom_up} on the integrated degree-of-importance map Eₜₒₜₐₗ can be controlled. If a is set to be 0.5, the top-down degree-of-importance map E_{top_down} and the bottom-up degree-of-importance map E_{bottom_up} can be reflected substantially equally in the integrated degree-of-importance map Eₜₒₜₐₗ.

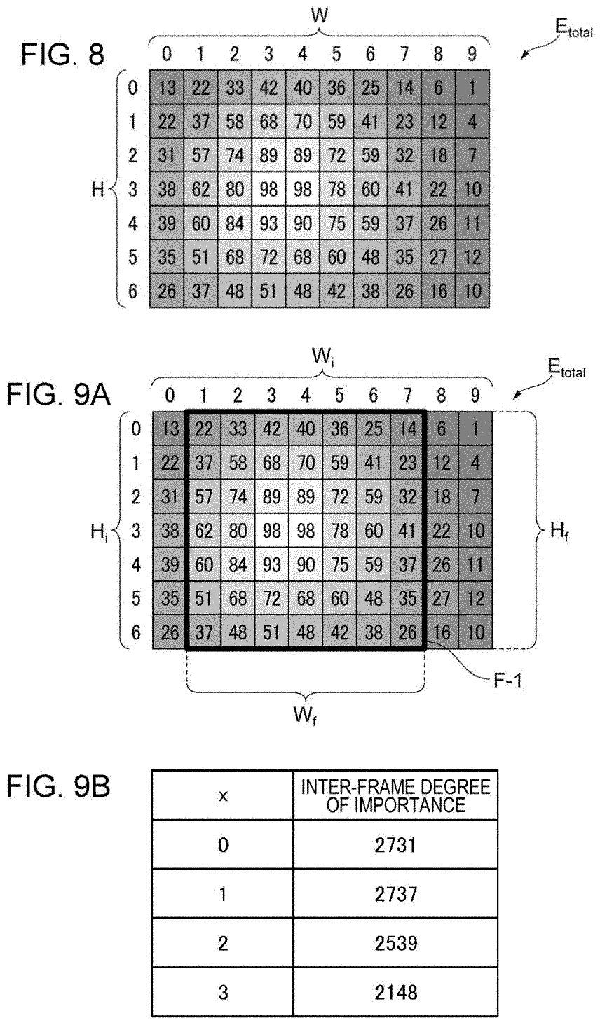

FIG. 8 illustrates an example of the integrated degree-of-importance map. The integrated degree-of-importance map Eₜₒₜₐₗ in FIG. 8 is obtained from the top-down degree-of-importance map E_{top_down} and the bottom-up degree-of-importance map E_{bottom_up} shown in FIGS. 7A and 7B by setting a in equation (5) to be 0.5. In the following description, the integrated degree-of-importance map Eₜₒₜₐₗ will simply be called the degree-of-importance map E unless otherwise stated.

Searching for the placement position of a trimming frame will be explained below. In the exemplary embodiment, a trimming frame is superimposed on a target image, and the total value of the degrees of importance of the individual small regions within the trimming frame is calculated. Hereinafter, this total value will be called the inter-frame degree of importance. While the position of the trimming frame is being shifted by every small region within the range of the target image, the inter-frame degree of importance at each position of the trimming frame is calculated. The position at which the inter-frame degree of importance is the highest is determined as the placement position of the trimming frame.

The size of the degree-of-importance map in the X direction is indicated by Wᵢ and that in the Y direction is indicated by Hᵢ. The size of the trimming frame in the X direction is indicated by W_{f} and that in the Y direction is indicated by H_{f}. The size (Wᵢ×Hᵢ) of the degree-of-importance map is the same size (W×H) of the target image, and the X-direction size and the Y-direction size of the degree-of-importance map and those of the trimming frame are represented by the number of small regions of the target image. The coordinate value x of the target image in the X direction is set to be 0 to W-1, while the coordinate value y in the Y direction is set to be 0 to H-1. The coordinate value i of the trimming frame in the X direction is set to be 0 to W_{f}-1, while the coordinate value j in the Y direction is set to be 0 to H_{f}-1.

The position of the trimming frame placed on the target image is expressed by the coordinate values of the target image on which the position of the coordinates (i, j)=(0, 0) of the trimming frame is superimposed. For example, when the position of the coordinates (i, j)=(0, 0) of the trimming frame is superimposed on that of the coordinates (x, y)=(0, 0) of the target image, the position of the trimming frame is (x, y)=(0, 0). When the position of the coordinates (i, j)=(W_{f}-1, H_{f}-1) of the trimming frame is superimposed on that of the coordinates (x, y)=(W-1, H-1) of the target image, the position of the trimming frame is (x, y)=(W-W_{f}, H-H_{f}). The placement position (xₒₚₜ, yₒₚₜ) of the trimming frame is the position at which the inter-frame degree of importance G(x, y) obtained when the position of the trimming frame is (x, y) becomes the highest.

Accordingly, the position (x, y) at which the inter-frame degree of importance G(x, y) expressed by the following equation (6) is obtained is determined as the placement position (xₒₚₜ, yₒₚₜ) of the trimming frame.

$${{arg max}_{0 \leq x \leq W - {W}_{f}}}_{0 \leq y \leq H - {H}_{f}} G ( x , y ) = {{arg max}_{0 \leq x \leq W - {W}_{f}}}_{0 \leq y \leq H - {H}_{f}} {\sum }_{i = 0}^{{W}_{f} - 1} {\sum }_{j = 0}^{{H}_{f} - 1} E ( x + i , y + j ) \qquad ( 6 )$$

FIGS. 9A and 9B illustrate an example of the placement of a trimming frame. FIG. 9A illustrates an example of the position of a trimming frame on a degree-of-importance map. FIG. 9B illustrates the relationship between the position of the trimming frame and the inter-frame degree of importance. In the example in FIG. 9A, the trimming frame F-1 is indicated by the thick frame lines by way of example. In the example in FIG. 9A, the size of the degree-of-importance map E is W=10, H=7, while the size of the trimming frame F-1 is W_{f}=7, H_{f}=7. The position of the trimming frame F-1 is (i, j)=(1, 0). In the example in FIG. 9A, since the size of the degree-of-importance map E in the Y direction and that of the trimming frame F-1 are the same (H=H_{f}), the Y-direction placement position in the placement position (xₒₚₜ, yₒₚₜ) of the trimming frame F-1 is fixed to yₒₚₜ=0. Hence, only the x-direction placement position xₒₚₜ is searched for while the trimming frame F-1 is being shifted in the X direction of the degree-of-importance map E.

FIG. 9B shows that the inter-frame degree of importance of the trimming frame F-1 at each position in the example in FIG. 9A is: G(0, 0)=2731; G(1, 0)=2737; G(2, 0)=2539; and G(3, 0)=2148. Since only the x-direction placement position xₒₚₜ is searched for as stated above, only the relationship between the value of x and the inter-frame degree of importance is shown in FIG. 9B. Since the maximum value of the inter-frame degree of importance is 2737, the placement position of the trimming frame F-1 in FIG. 9A is (xₒₚₜ, yₒₚₜ)=(1, 0). In this manner, the trimming frame F-1 is placed at a position of the target image I-1 where the degree of importance in the region inside the trimming frame F-1 becomes the highest.

As described above, the placement position of a trimming frame, which is an example of an object, is determined based on a degree-of-importance map. The placement position of a trimming frame can be controlled by setting a weighting factor for the trimming frame. This will be explained below. If the weighting factor is set for a trimming frame, the degree of importance within the trimming frame can be adjusted. As a result of changing the manner in which the weighting factor is set, the intension of a user may be reflected in the composition of an image to be cropped by trimming.

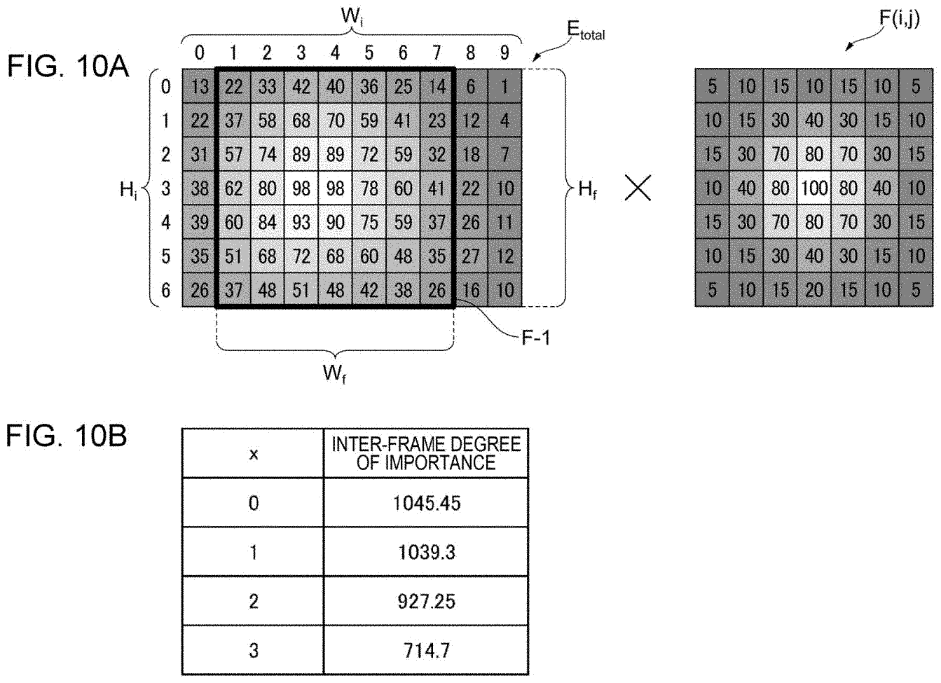

FIGS. 10A and 10B illustrate an example of the placement of a trimming frame provided with the weighting factor. FIG. 10A illustrates the position of the trimming frame on a degree-of-importance map and an example of the weighting factor set for the trimming frame. FIG. 10B illustrates the relationship between the position of the trimming frame and the inter-frame degree of importance. In the example in FIG. 10A, the size and the coordinates of the degree-of-importance map E and those of the trimming frame F-1 are similar to those shown in FIG. 9A. The position of the trimming frame F-1 in the degree-of-importance map E in FIG. 10A is (i, j)=(0, 0). The weighting factor F(i, j) is set for the position of the coordinates (i, j) of the trimming frame F-1.

To search for the placement position of the trimming frame F-1 provided with the weighting factor F(i, j), the inter-frame degree of importance G(x, y) is calculated by multiplying the degree of importance of each set of coordinates of the degree-of-importance map E by the weighting factor F(i, j) set for the corresponding coordinates in the trimming frame F-1. The weighting factor F(i, j) shown in FIG. 10A is expressed by percentage. For example, since the position of the trimming frame F-1 is (i, j)=(0, 0), the degree of importance of the coordinates (x, y)=(0, 0) is calculated as 13×0.05=0.65 and that of the coordinates (x, y)=(1, 0) is calculated as 22×0.10=2.20. The placement position (xₒₚₜ, yₒₚₜ) of the trimming frame F-1 is the position at which the inter-frame degree of importance G(x, y) becomes the highest. Hence, the position (x, y) at which the inter-frame degree of importance G expressed by the following equation (7) is obtained is determined as the placement position (xₒₚₜ, yₒₚₜ) of the trimming frame F-1.

$${{arg max}_{0 \leq x \leq W - {W}_{f}}}_{0 \leq y \leq H - {H}_{f}} G ( x , y ) = {{arg max}_{0 \leq x \leq W - {W}_{f}}}_{0 \leq y \leq H - {H}_{f}} {\sum }_{i = 0}^{{W}_{f} - 1} {\sum }_{j = 0}^{{H}_{f} - 1} F ( i , j ) E ( x + i , y + j ) \qquad ( 7 )$$

FIG. 10B shows that the inter-frame degree of importance of the trimming frame F-1 at each position in the example in FIG. 10A is obtained as follows by reflecting the weighting factor F(i, j) in the inter-frame degree of importance shown in FIG. 10A: G(0, 0)=1045.45, G(1, 0)=1039.3, G(2, 0)=927.25, and G(3, 0)=714.7. As in the example in FIGS. 9A and 9B, since only the x-direction placement position xₒₚₜ is searched for, only the relationship between the value of x and the inter-frame degree of importance is shown in FIG. 10B. The result of FIG. 10B shows that the placement position of the trimming frame F-1 in FIG. 10A is (xₒₚₜ, yₒₚₜ)=(0, 0). In this manner, the trimming frame F-1 is placed at a position of the target image I-1 where the degree of importance in the region surrounded by the trimming frame F-1 becomes the highest.

In the example in FIG. 10A, the largest value of the weighting factor F(i, j) is set for the small region at the center of the trimming frame F-1, while a smaller value is set for a small region farther separated from the center. With the weighting factor set in this manner, when the positional relationship is such that a small region having a high degree of importance in the degree-of-importance map E is located at or around the center of the trimming frame F-1, the resulting inter-frame degree of importance becomes high. The position that satisfies such a positional relationship is determined as the placement position of the trimming frame F-1. As a result of trimming the image using the trimming frame F-1, a region having a high degree of importance, such as a subject serving as a main theme, is positioned at the center of the cropped image.

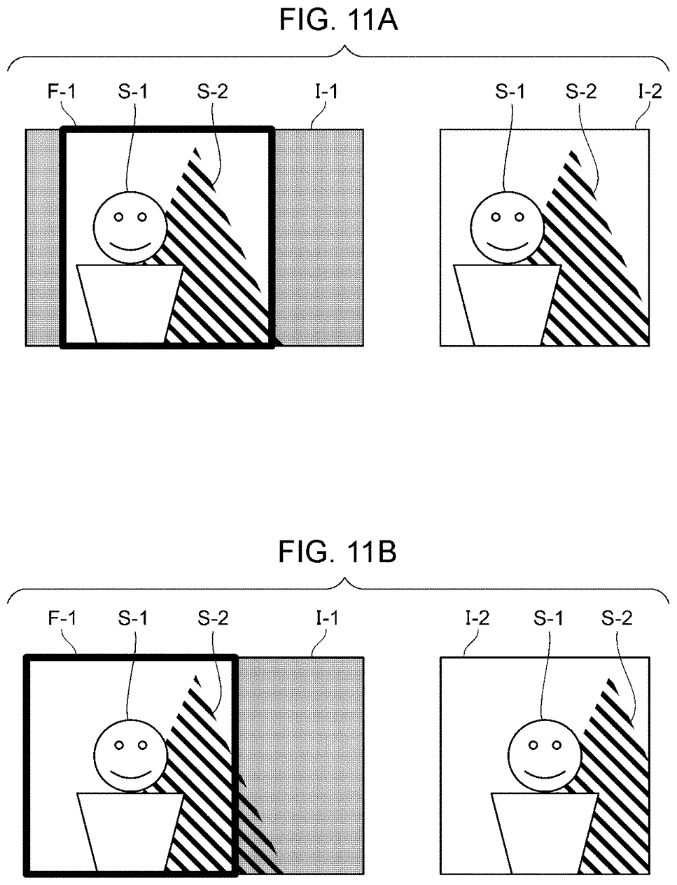

FIGS. 11A and 11B illustrate a comparison of a trimming result with the use of the weighting factor and that without the use of the weighting factor. FIG. 11A illustrates a trimming result without the use of the weighting factor. FIG. 11B illustrates a trimming result with the use of the weighting factor shown in FIG. 10A. In each of FIGS. 11A and 11B, the placement position of the trimming frame F-1 in the target image I-1 and the image I-2, which is a trimming result, are shown.

As discussed above, regardless of with or without the use of the weighting factor, the trimming frame F-1 is placed at a position of the target image I-1 where the degree of importance in the region surrounded by the trimming frame F-1 becomes the highest. However, the placement position of the trimming frame F-1 with the use of the weighting factor becomes different from that without the use of the weighting factor. In the example in FIG. 11A, as discussed with reference to FIGS. 3B and 3C, the entirety of the subject S-1, which is the main subject, is drawn in the image I-2, while the subject S-2, which is the background subject, occupies a considerable amount of the area of the image I-2 though part of the subject S-2 is missing. As a result, a well-balanced screen (composition) is generated as a whole. In contrast, in the example in FIG. 11B, the subject S-1, which is the main subject, is positioned at the center of the screen, and a composition in which the subject S1 (main theme) is placed at the center of the screen is implemented.

In the examples explained with reference to FIGS. 10A through 11B, the composition in which a region having a high degree of importance is placed at the center of the screen has been discussed by way of example. The type of composition achieved by using the weighting factor is not limited to the above-described type. As a result of changing the manner in which the weighting factor is set, various types of compositions, such as compositions using bisections, rules of thirds, and diagonal lines, can be achieved.

### (Placement of Image Object)

Processing for placing an image object on a background image by using a degree-of-importance map in the exemplary embodiment will be described below. To place an image object on a background image, a placement region where the image object is placeable on the background image is first set. Then, in this placement region, the image object is placed at a position specified based on a degree-of-importance map used in the exemplary embodiment. In the above-described processing for placing a trimming frame, to determine an image to be cropped from a target image by trimming, a trimming frame as an object is placed on the target image. The trimming frame is thus placed on the target image so as to include a portion of the target image having a high degree of importance. In contrast, in processing for placing an image object on a background image, it is necessary that the image object be placed at a position of the background image where the degree of importance is low, in other words, the image object be placed at a position where it does not disturb a subject of the background image.

In processing for placing an image object on a background image, a degree-of-importance map of the background image is created, and also, a weighting factor is set for the image object in accordance with the content of the image object. The degree-of-importance map of the background image is generated based on the degree of importance of the background image and also based on the degree of importance of the placement region where the image object is placeable. The degree of importance is calculated based on the saliency, which is the characteristics of the background image, as discussed in the above-described processing for placing a trimming frame.

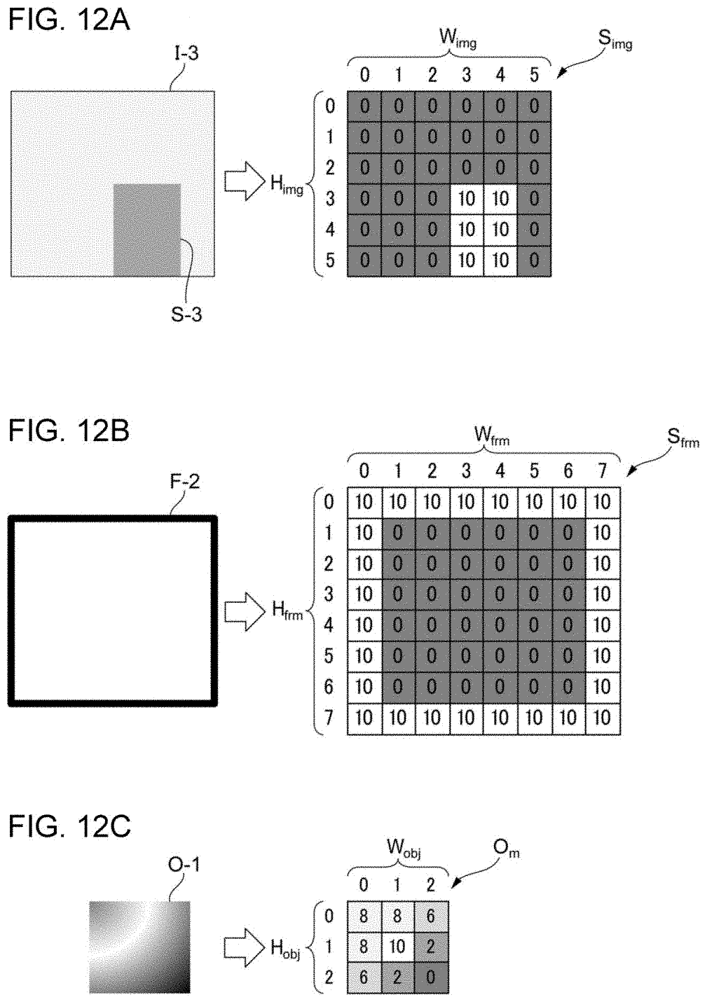

FIG. 12A illustrates an example of a saliency map based on a background image. FIG. 12B illustrates an example of a saliency map set for a placement region of an image object. FIG. 12C illustrates examples of the weighting factor set for the image object.

In FIG. 12A, an example of a saliency map S_{img} is illustrated. In the saliency map S_{img}, 36 small regions (W_{img}×H_{img}=6×6) are set in a background image I-3, where W_{img} is the number of X-direction (horizontal direction) small regions and H_{img} is the number of Y-direction (vertical direction) small regions. In the saliency map S_{img}, coordinate values of 0 to 5 are given from the left to the right in the X direction, while coordinate values of 0 to 5 are given from the top to the bottom in the Y direction. The saliency map S_{img} is a map generated by integrating a top-down saliency map and a bottom-up saliency map, each of which is created for the small regions of the background image I-3. A procedure for creating a top-down saliency map and that for a bottom-up saliency map are similar to those discussed in the above-described processing for placing a trimming frame, and an explanation thereof will be omitted. Regarding the above-described processing for placing a trimming frame, a degree-of-importance map is created from a top-down saliency map and another degree-of-importance map is created from a bottom-up saliency map, and the two degree-of-importance maps are integrated. In the example in FIG. 12A, the saliency map S_{img} is generated by integrating a top-down saliency map and a bottom-up saliency map.

A further explanation will be given of the background image I-3 and the saliency map S_{img} shown in FIG. 12A. In the background image I-3, a subject S-3 is drawn on the bottom right of the screen. Accordingly, in the saliency map S_{img}, the saliency values in the six small regions (x, y)=(3 to 4, 3 to 5) are “10”, while those in the other small regions are “0”, where x is the coordinate value in the X direction and y is the coordinate value in the Y direction.

In FIG. 12B, an example of a saliency map S_{frm} generated based on a region setting frame F-2 used for setting a placement region in the background image I-3 is shown. The region setting frame F-2 is used for setting a placement region of an image object on the background image I-3. As a result of setting the placement region, only inside the placement region on the background image I-3 is used to search for the placement position of the image object. For example, if the image object is to be placed somewhere in the right half of the background image I-3, the region setting frame F-2 for setting the right-half region of the background image I-3 to be the placement region is used. If the entirety of the background image I-3 is used to search for the placement position of the image object, the region setting frame F-2 for setting the entirety of the background image I-3 to be the placement region is used. The size and the area of the region setting frame F-2 may be set in response to an instruction from a user or in accordance with a predetermined rule. Without a user instruction nor a rule, the region setting frame F-2 for setting the entirety of the background image I-3 to be the placement region may be used. In the example in FIG. 12B, the region setting frame F-2 for setting the entirety of the background image I-3 shown in FIG. 12A to be the placement region is used.

The saliency map S_{frm} based on the region setting frame F-2 is created, not based on the content of the background image I-3, but based on the shape of the region setting frame F-2. In the example in FIG. 12B, the saliency values in the small regions inside the region setting frame F-2, which serves as a placement region, are set to be “0”. On the outer side of the region setting frame F-2, one layer of small regions is added, and the saliency values in these small regions are set to be “10”. In the example in FIG. 12B, the size of the saliency map S_{frm} based on the region setting frame F-2 is (W_{frm}×H_{frm}=8×8). The shape and saliency values of the saliency map S_{frm} based on the region setting frame F-2 are not limited to those shown in FIG. 12B. Another shape and other saliency values may be used for the saliency map S_{frm} if the resulting saliency map reflects the characteristics that influence the degrees of importance in the region setting frame F-2.

In FIG. 12C, an example of a weighting factor map Oₘ set for an image object O-1 to be placed on the background image I-3 is shown. In the image object O-1 in FIG. 12C, 9 small regions (W_{obj}×H_{obj})=3×3) are set in accordance with the size of the image object O-1. In the weighting factor map Oₘ, the weighting value is set for each small region of the image object O-1 in accordance with the content of the corresponding portion of the image object O-1. The weighting values are set based on the image of the image object O-1 in accordance with a predetermined rule. This predetermined rule is not limited to a particular rule. For example, the weighting values may be set in accordance with the level of transparency of a corresponding portion of the image. More specifically, a larger weighting value may be set for a small region having a lower level of transparency of the image, while a smaller weighting value may be set for a small region having a higher level of transparency of the image. As a result of setting the weighting values for the small regions of the image object O-1, the placement position of the image object O-1 on the background image I-3 can be searched for by reflecting the weighting values in the degrees of importance calculated for the individual small regions of the background image I-3. This will be discussed later in detail.

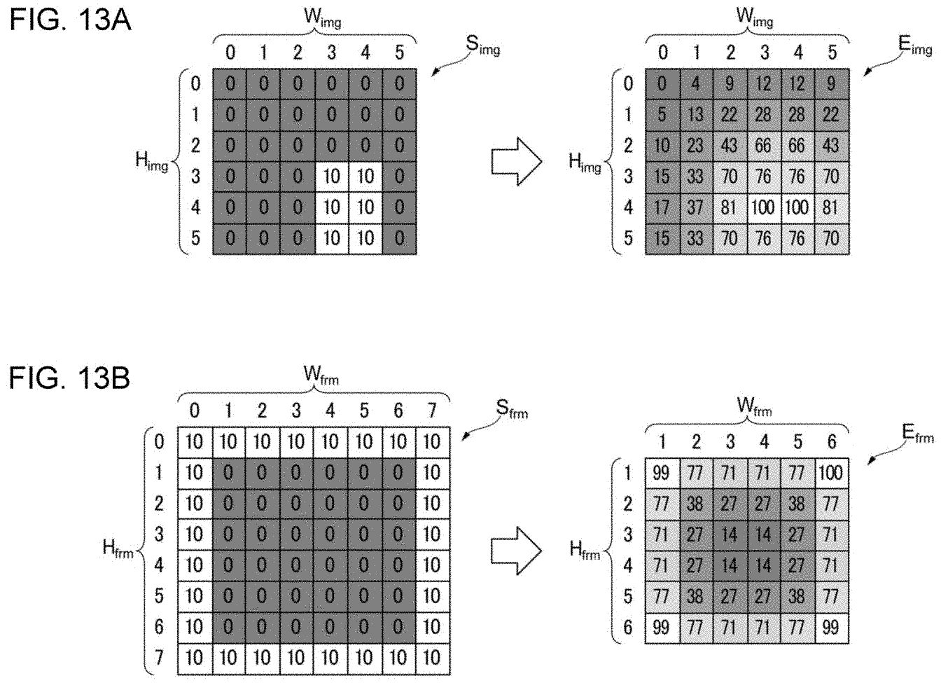

FIG. 13A illustrates the saliency map S_{img} of the background image I-3 shown in FIG. 12A and a degree-of-importance map E_{img} based on the saliency map S_{img}. FIG. 13B illustrates the saliency map S_{frm} of the region setting frame F-2 shown in FIG. 12B and a degree-of-importance map E_{frm} based on the saliency map S_{frm}.

In FIG. 13A, the saliency map S_{img} of the background image I-3 is shown at the tail of the arrow, while the degree-of-importance map E_{img} based on the saliency map S_{img} is shown at the head of the arrow. In FIG. 13B, the saliency map S_{frm} of the region setting frame F-2 is shown at the tail of the arrow, while the degree-of-importance map E_{frm} based on the saliency map S_{frm} is shown at the head of the arrow. In the following description, the saliency and the degree of importance of each small region will be called the saliency S (x, y) and the degree of importance E (x, y), respectively, appended with the coordinate values.

Calculating of the degree of importance of each small region is similar to that discussed in the above-described processing for placing a trimming frame with reference to FIGS. 7A and 7B. This will be discussed more specifically. One of the small regions is set to be a small region of interest, and small regions other than the small region of interest are set to be reference small regions. The degree of importance of the small region of interest is calculated based on the saliency value of each reference small region. The influence of each reference small region on the small region of interest is calculated by the function D_{x,y}(i, j) expressed by equation (1), where the coordinates of the small region of interest are indicated by (x, y) and the coordinates of each reference value are indicated by (i, j). It is noted that i≠x and j≠y.

The degree of importance E_{img}(x, y) of the small region of interest (x, y) in the background image I-3 is calculated by the following equation (8). The value of the degree of importance calculated for each small region is normalized by equation (4).

$${E}_{img} ( x , y ) = {\sum }_{i = 0}^{{W}_{img} - 1} {\sum }_{j = 0}^{{H}_{img} - 1} {S}_{img} ( i , j ) {D}_{x , y} ( i , j ) \qquad ( 8 )$$

The degree of importance E_{frm}(x, y) of the small region of interest (x, y) in the region setting frame F-2 is calculated by the following equation (9). The size of the saliency map S_{frm} shown in FIG. 12B is larger than the region setting frame F-2 by an amount equal to small regions disposed on the outer side of the region setting frame F-2. These small regions are disposed for reflecting the characteristics that influence the degree of importance in the region setting frame F-2, and they thus disappear in the degree-of-importance map E_{frm}. Accordingly, the ranges of the coordinates (i, j) of the reference small regions are i=0 to W_{frm}-1, and j=0 to H_{frm}-1. The ranges of the coordinates (x, y) of the small region of interest are x=1 to W_{frm}-2, and y=1 to H_{frm}-2. The value of the degree of importance calculated for each small region is normalized by equation (4).

$${E}_{frm} ( x , y ) = {\sum }_{i = 0}^{{W}_{frm} - 1} {\sum }_{j = 0}^{{H}_{frm} - 1} {S}_{frm} ( i , j ) {D}_{x , y} ( i , j ) \qquad ( 9 )$$

The degree-of-importance map E_{img} of the background image I-3 and the degree-of-importance map E_{frm} of the region setting frame F-2 obtained as described above are integrated with each other, thereby resulting in an integrated degree-of-importance map Eₜₒₜₐₗ The integrated value of the degree of importance of each small region is calculated by the following equation (10).

Eₜₒₜₐₗ=αE_{img}+(1−α)E_{frm} (10)

In equation (10), α is set to be a suitable value, and then, the level of influence of the degree-of-importance map E_{img} of the background image I-3 and that of the degree-of-importance map E_{frm} of the region setting frame F-2 on the integrated degree-of-importance map Eₜₒₜₐₗ can be controlled. If α is set to be 0.5, the degree-of-importance map E_{img} of the background image I-3 and the degree-of-importance map E_{frm} of the region setting frame F-2 can be reflected substantially equally in the integrated degree-of-importance map Eₜₒₜₐₗ.

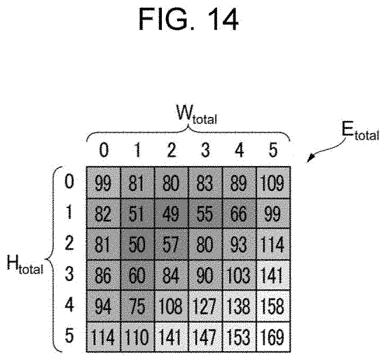

FIG. 14 illustrates an example of the integrated degree-of-importance map. The integrated degree-of-importance map Eₜₒₜₐₗ in FIG. 14 is obtained from the degree-of-importance map E_{img} of the background image I-3 shown in FIG. 13A and the degree-of-importance map E_{frm} of the region setting frame F-2 shown in FIG. 13B by setting a in equation (10) to be 0.5. In the following description, the integrated degree-of-importance map Eₜₒₜₐₗ will simply be called the degree-of-importance map E unless otherwise stated.

Searching for the placement position of the image object O-1 on the background image I-3 will be explained below. In the exemplary embodiment, the image object O-1 is disposed on the background image I-3, and the total value of the degrees of importance of the individual small regions of the background image I-3 on which the corresponding small regions of the image object O-1 are superimposed is calculated. Hereinafter, this total value will be called the target degree of importance. As shown in FIG. 12C, the weighting value is set for each small region of the image object O-1. The degrees of importance of the small regions of the background image I-3 on which the corresponding small regions of the image object O-1 are superimposed are converted by using the weighting values set for the corresponding small regions of the image object O-1. While the position of the image object O-1 is being shifted by every small region within the range of the background image O-3, the target degree of importance at each position of the image object O-1 is calculated. The position at which the target degree of importance becomes the lowest is determined as the placement position of the image object O-1.

The size of the degree-of-importance map E in the X direction is indicated by Wₜₒₜₐₗ and that in the Y direction is indicated by Hₜₒₜₐₗ. The size of the image object O-1 in the X direction is indicated by W_{obj} and that in the Y direction is indicated by H_{obj}. The size (Wₜₒₜₐₗ×Hₜₒₜₐₗ) of the degree-of-importance map E is the same size (W_{img}×H_{img}) of the background image I-3, and the X-direction size and the Y-direction size of the degree-of-importance map E and those of the image object O-1 are represented by the number of small regions of the background image I-3. The coordinate value x of the background image I-3 in the X direction is set to be 0 to W_{img}-1, while the coordinate value y in the Y direction is set to be 0 to H_{img}-1. The coordinate value i of the image object O-1 in the X direction is set to be 0 to W_{obj}-1, while the coordinate value j in the Y direction is set to be 0 to H_{obj}-1.

The position of the image object O-1 placed on the background image I-3 is expressed by the coordinate values of the background image I-3 on which the position of the coordinates (i, j)=(0, 0) of the image object O-1 is superimposed. For example, when the position of the coordinates (i, j)=(0, 0) of the image object O-1 is superimposed on that of the coordinates (x, y)=(0, 0) of the background image I-3, the position of the image object O-1 is (x, y)=(0, 0). When the position of the coordinates (i, j)=(W_{obj}-1, H_{obj}-1) of the image object O-1 is superimposed on that of the coordinates (x, y)=(W_{img}-1, H_{img}-1) of the background image I-3, the position of the image object O-1 is (x, y)=(W_{img}-W_{obj}, H_{img}-H_{obj}).

As shown in FIG. 12C, the weighting factor is set for the image object O-1. The weighting value set by using the weighting factor map Oₘ at the coordinates (i, j) of the image object O-1 is indicated by Oₘ(i, j). To search for the placement position of the image object O-1, the target degree of importance is calculated by multiplying the degree of importance of each set of coordinates of the degree-of-importance map E by the weighting value Oₘ(i, j) at the corresponding coordinates of the weighting factor map Oₘ. The placement position (xₒₚₜ, yₒₚₜ) of the image object O-1 is the position at which the target degree of importance L(x, y) obtained when the position of the image object O-1 is (x, y) becomes the lowest. Accordingly, the position (x, y) at which the target degree of importance L(x, y) expressed by the following equation (11) is obtained is determined as the placement position (xₒₚₜ, yₒₚₜ) of the image object O-1.

$${{arg min}_{0 \leq x \leq {W}_{img} - {W}_{obj}}}_{0 \leq y \leq {H}_{img} - {H}_{obj}} L ( x , y ) = {{arg min}_{0 \leq x \leq {W}_{img} - {W}_{obj}}}_{0 \leq y \leq {H}_{img} - {H}_{obj}} {\sum }_{i = 0}^{{W}_{obj} - 1} {\sum }_{j = 0}^{{H}_{obj} - 1} {O}_{m} ( i , j ) E ( x + i , y + j ) \qquad ( 11 )$$

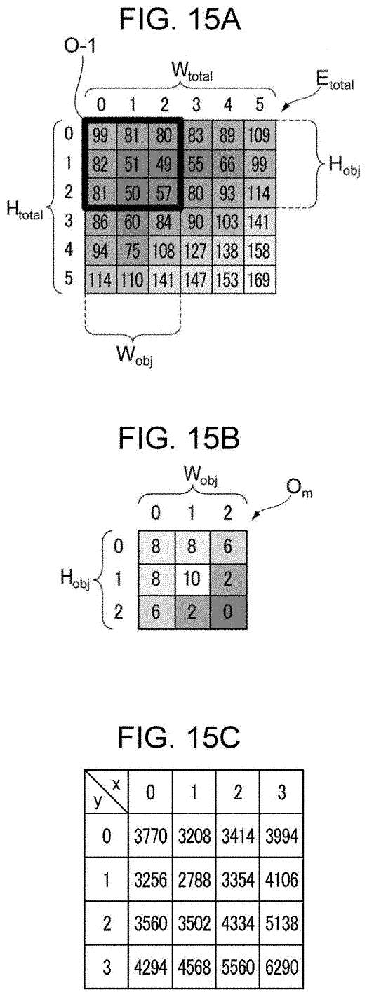

FIGS. 15A through 15C illustrate an example of the placement of an image object. FIG. 15A illustrates an example of the placement position of an image object on a degree-of-importance map. FIG. 15B illustrates an example of a weighting factor map for the image object. FIG. 15C illustrates the relationship between the position of the image object and the target degree of importance. The degree-of-importance map E shown in FIG. 15A (written as Eₜₒₜₐₗ) is the same as that shown in FIG. 14, and the weighting factor map Oₘ shown in FIG. 15B is the same as that shown in FIG. 12C.

In the example in FIG. 15A, the position of the image object O-1 is indicated by the thick frame lines by way of example. The size of the degree-of-importance map E is Wₜₒₜₐₗ=W_{img}=6 and Hₜₒₜₐₗ=H_{img}=6, while the size of the image object O-1 is W_{obj}=3 and H_{obj}=3. The position of the image object O-1 is j)=(0, 0). In the example in FIG. 15A, as a result of shifting the position of the image object O-1 by every small region in the X direction and in the Y direction, the target degree of importance L(x, y) is calculated for 16 portions at the coordinates (x, y)=(0 to 3, 0 to 3) on the background image I-3. These 16 portions are thus used to search for the placement position (xₒₚₜ, yₒₚₜ) of the image object O-1.

For example, when the position of the image object O-1 is (0, 0), the target degree of importance L(0, 0) is calculated as 99×8+81×8+80×6+82×8+51×10+49×2+81×6+50×2+57×0=3770. Likewise, as shown in FIG. 15C, L(1, 0)=3208, L(2, 0)=3414, L(3, 0)=3994, L(0, 1)=3256, L(1, 1)=2788, L(2, 1)=3354, L(3, 1)=4106, L(0, 2)=3560, L(1, 2)=3502, L(2, 2)=4334, L(3, 2)=5138, L(0, 3)=4294, L(1, 3)=4568, L(2, 3)=5560, and L(3, 3)=6290. The result of FIG. 15C shows that the minimum value is 2788, and the placement position (xₒₚₜ, yₒₚₜ) of the image object O-1 in the example in FIG. 15A is (1, 1).

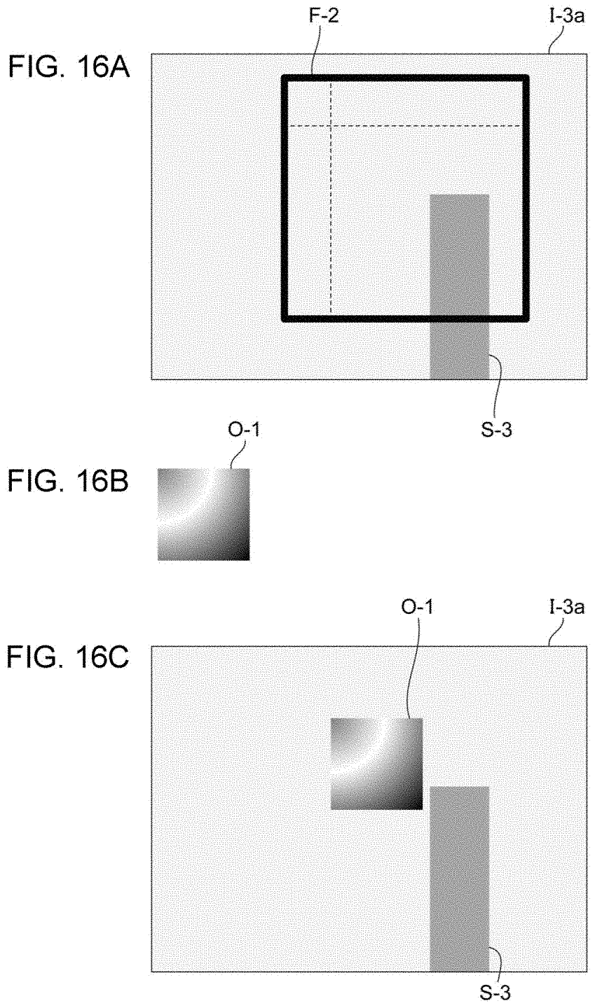

FIGS. 16A through 16C illustrate an example in which a composite image is created by placing an image object on a background image. FIG. 16A illustrates a state in which a placement region is set in a background image and the placement position of an image object is determined. FIG. 16B illustrates the image object. FIG. 16C illustrates a state in which the background image and the image object are combined with each other. The image object O-1 shown in FIG. 16B is the same as that shown in FIG. 12C.

In the example in FIG. 16A, a region setting frame F-2 is set in a background image I-3a. With the region setting frame F-2, the placement region for setting the image object O-1 is set. The background image I-3a shown in FIG. 16A contains the background image I-3 shown in FIG. 12A. In other words, the background image I-3 is part of the background image I-3a. In the example in FIG. 16A, the region specified by the region setting frame F-2 is the same as the region of the background image I-3.

The two broken lines within the region setting frame F-2 shown in FIG. 16A represent the placement position of the image object O-1. The intersection of the two broken lines is the placement position (xₒₚₜ, yₒₚₜ) of the image object O-1. As discussed with reference to FIGS. 15A through 15C, the image object O-1 is placed such that the small region at the top left corner of the image object O-1 is aligned to the placement position (xₒₚₜ, yₒₚₜ). With this arrangement, the image object O-1 can be placed at a position of the target region of the background image I-3a where the degree of importance of the region of the background image I-3 on which the image object O-1 is superimposed becomes the lowest.

As a result of determining the placement position of the image object O-1 as described above, as shown in FIG. 16C, the image object O-1 is placed at a position within the target region (surrounded by the two broken lines in FIG. 16A) set in the background image I-3a so as not to disturb the subject S-3. Additionally, the image object O-1 within the target region is not too close to the edge of the target region and is positioned in a well-balanced manner.

### [Application Examples of Degree-of-Importance Map]

As to automatic placement of an object using a degree-of-importance map used in the exemplary embodiment, the basic approach to determining the placement position of an object has been discussed above through illustration of processing for placing a trimming frame used for trimming a target image and processing for placing an image object on a background image. The degree-of-importance map used in the exemplary embodiment may be applied, not only to the above-described processing for determining the placement position of an object, but also to image processing using another approach. Application examples of the degree-of-importance map used in the exemplary embodiment will be discussed below through illustration of specific examples of image processing.

### (Changing of Object Size)

There may be a case in which it is desirable to change the size of an object to be placed on a background image. In this case, the size of an object, as well as the placement position, may be determined in accordance with the content of a background image by using the degree-of-importance map in the exemplary embodiment. In a specific example, the size of the object may be changed to have the largest area on the condition that the object can be contained in a region whose degree of importance is lower than or equal to a specific value. In this example, the size of the original object is enlarged or reduced while the similarity of the figure of this object is maintained. The object adjuster 170 of the image processing apparatus 100, for example, may change the size of the object. After the size of the object is changed, the placement position adjuster 160 of the image processing apparatus 100, for example, may adjust the placement position of the object.

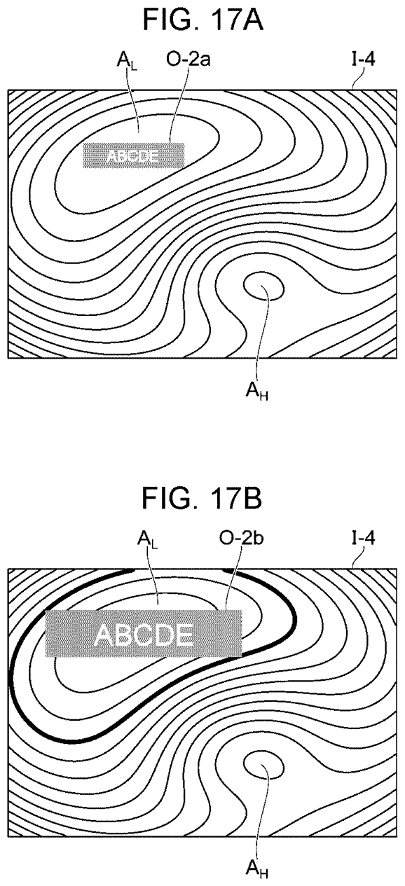

FIGS. 17A and 17B illustrate an example of changing of the size of an object. FIG. 17A illustrates an example in which an object of the initial size is placed on a background image. FIG. 17B illustrates an example in which an object is placed on the background image after the size of the object is changed. In the examples in FIGS. 17A and 17B, the degree-of-importance map is visually expressed on a background image I-4 by using the contour lines, each of which links small regions having the same degree of importance. The contour lines show that a region A_{L} having a low degree of importance is disposed at the top left portion of the background image I-4, while a region A_{H} having a high degree of importance is disposed at the bottom right portion of the background image I-4. Objects O-2a and O-2b respectively shown in FIGS. 17A and 17B are rectangular image objects containing text “ABCDE”.

In the example in FIG. 17A, as discussed with reference to FIGS. 15A through 15C, the object O-2a is placed at a position where the degree of importance of the background image I-4 on which the object O-2a superimposed becomes the lowest, and the object O-2a is contained in the region A_{L}. In the example in FIG. 17B, while maintaining the similarity of the figure of the object O-2a, the object O-2b is enlarged to have the largest size to such a degree not to exceed the region indicated by the third contour line (indicated by the thick line in FIG. 17B) counted from the region A_{L}.

The placement of an object, such as that shown in FIG. 17B, may be performed by placing the original size of the object, such as that in FIG. 17A, on a background image according to the procedure discussed with reference to FIGS. 15A through 15C and then by changing the size of the object. Alternatively, the placement of an object may be performed without following the procedure discussed with reference to FIGS. 15A through 15C, that is, the object may be placed by searching for the placement position of the object within a region specified by the degree-of-importance map while the size of the object is being changed. Although the object is placed with an enlarged size in the example in FIGS. 17A and 17B, the object may be reduced and placed in accordance with the region whose degree of importance is lower than or equal to a specific value. The specific value of the degree of importance may be automatically set by the image processing apparatus 100 using the function of the object adjuster 170 in accordance with a predetermined rule or set by the image processing apparatus 100 in response to an instruction from a user. An example of the predetermined rule is that the average value of the degrees of importance in the degree-of-importance map is used as the specific value.

### (Rotation of Object)

There may be a case in which it is desirable to change the angle of an object to be placed on a background image. In this case, the placement angle of the object, as well as the placement position, may be determined in accordance with the content of the background image by using the degree-of-importance map in the exemplary embodiment. In a specific example, the object may be rotated about a specific point, and the angle at which the degree of importance of the background image overlapping the object becomes the lowest may be used as the placement angle of the object. The object may be rotated by the placement position adjuster 160 of the image processing apparatus 100, for example.

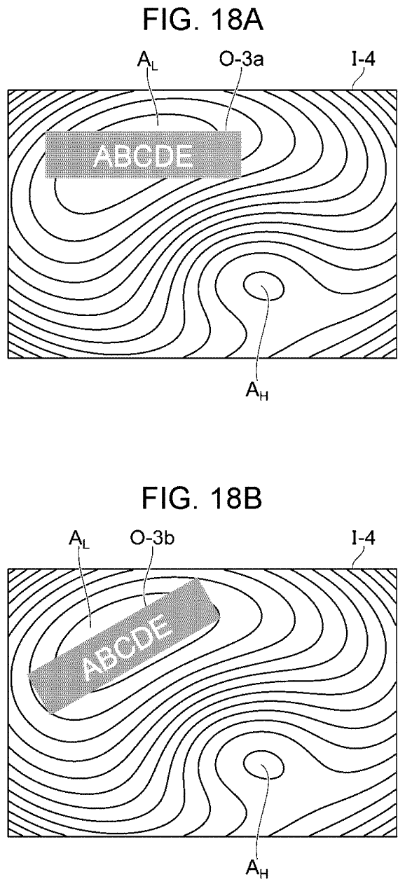

FIGS. 18A and 18B illustrate an example of rotating of an object. FIG. 18A illustrates an example in which an object is placed on a background image without changing the angle of the object. FIG. 18B illustrates an example in which the object is placed on the background image by changing the angle of the object shown in FIG. 18A. In the examples in FIGS. 18A and 18B, the degree-of-importance map is visually expressed on a background image I-4 by using the contour lines, each of which links small regions having the same degree of importance. The contour lines show that a region A_{L} having a low degree of importance is disposed at the top left portion of the background image I-4, while a region A_{H} having a high degree of importance is disposed at the bottom right portion of the background image I-4. Objects O-3a and O-3b respectively shown in FIGS. 18A and 18B are rectangular image objects containing text “ABCDE”.

In the example in FIG. 18A, as discussed with reference to FIGS. 15A through 15C, the object O-3a is placed at a position where the degree of importance of the background image I-4 on which the object O-3a is superimposed becomes the lowest. In the example in FIG. 18B, the angle of the object O-3b is changed so that the degree of importance of the background image I-4 on which the object O-3b is superimposed becomes even lower than that when the object O-3a is placed. After the angle of the object is changed as shown in FIG. 18B, the object may be moved so that the degree of importance of the background image on which the object is superimposed becomes even lower, and then, the angle of the object may be changed again. In this manner, it is possible to search for the placement position and the placement angle of the object by repeating moving and rotating of the object.

### (Placement of Discrete Objects)

There may be a case in which it is desirable to combine discretely placed plural objects with a background image, such as a case in which an image of scattered stars or petals is combined with the entirety of a background image. In this case, plural discrete objects may be used as object materials, and a region, which is larger than a background image, may be used as an object. Then, the placement position of the object materials on this region may be searched for and determined by using the degree-of-importance map in the exemplary embodiment. Placing of discrete object materials can be regarded as placing of an object larger than a background image. The placement position of such an object may be determined by the placement position determiner 150 of the image processing apparatus 100, for example.

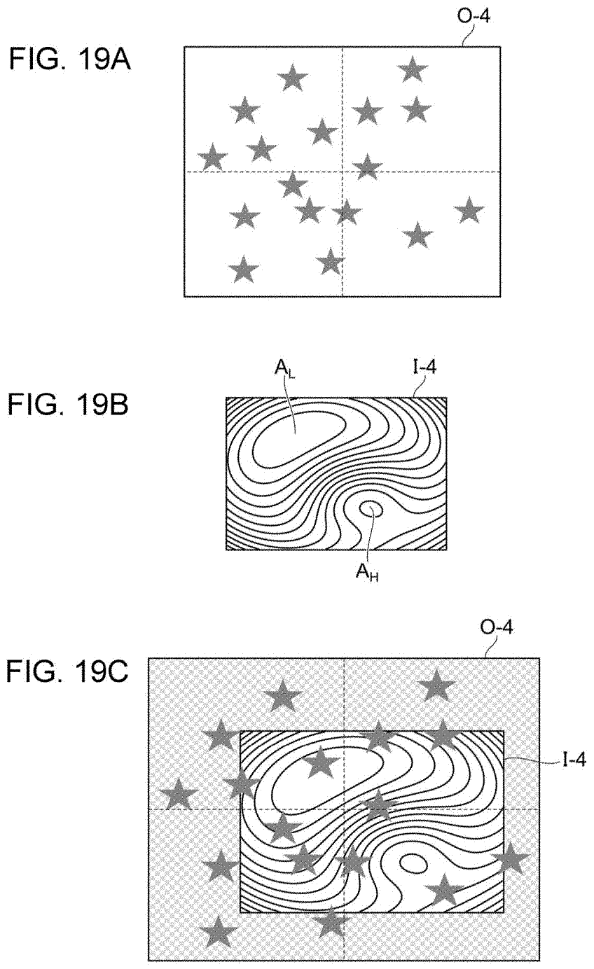

FIGS. 19A through 19C illustrate a placement example of discrete objects. FIG. 19A illustrates an example of an object constituted by discrete object materials. FIG. 19B illustrates an example of a background image. FIG. 19C illustrates an example in which the object is placed on the background image. The background image I-4 shown in FIG. 19B is similar to that in FIGS. 17A through 18B.

As shown in FIG. 19A, plural object materials (star-shaped materials in FIG. 19A) are discretely placed in an object O-4. When the object O-4 is to be placed on the background image, the size and the angle of the object O-4 may be changed. In the example in FIG. 19C, the object O-4 in FIG. 19A is enlarged and is placed on the background image I-4. The position of the object O-4 on the background image I-4 is determined based on the position of a specific point of the object O-4 on the background image I-4, for example. The specific point may be the center point of the object O-4 (the intersection of the broken lines in FIGS. 19A and 19C).

In searching for the placement position of the object O-4, the degree of importance of the space outside the background image I-4 is set to be 0. The weighing factor is set for the object O-4 and the weighting value for a location without the object materials is set to be 0. With this arrangement, as shown in FIG. 19C, the object materials are disposed, not in regions having a high degree of importance, but in regions having a low degree of importance in the background image I-4.

In the above-described example, the position of the object O-4 on the background image I-4 is determined based on the position of the specific point of the object O-4. A certain limitation may be imposed on the placement position of the object O-4. If it is possible to change the size and/or the angle of the object O-4, the range of the size and/or the angle to be changed may be restricted. In the example in FIGS. 19A through 19C, the placement position of the object O-4 is searched for, based on the degree-of-importance map generated for the entirety of the background image I-4. In contrast, as discussed with reference to FIGS. 12A through 16C, a placement region may be set in the background image I-4 and the placement position of the object O-4 may be searched for based on the degree-of-importance map generated for this placement region.

### (Transformation of Object)

There may be a case in which it is desirable to transform an object to be placed on a background image. In this case, the shape of the object itself, as well as the placement position and the placement angle, may be determined by using the degree-of-importance map in the exemplary embodiment. In a specific example, the object may be transformed to have the largest size on the condition that the object can be included in a region whose degree of importance is lower than or equal to a specific value. Transforming of the object may be performed by the object adjuster 170 of the image processing apparatus 100, for example. After the object is transformed, the placement position adjuster 160 of the image processing apparatus 100, for example, may adjust the placement position of the object.

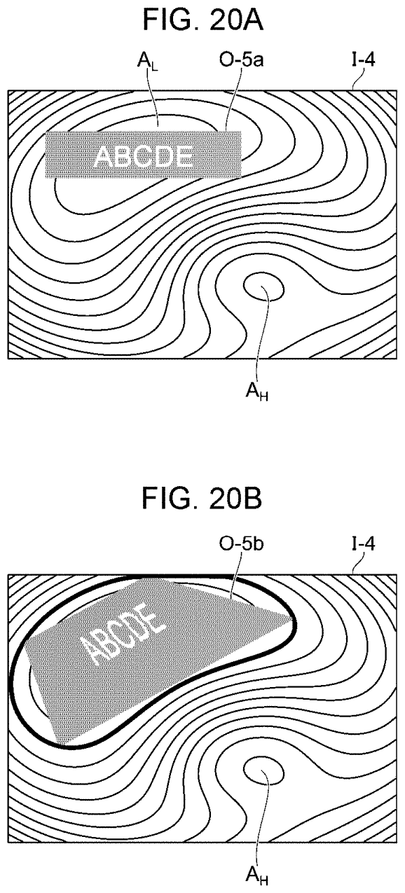

FIGS. 20A and 20B illustrate an example of transformation of an object. FIG. 20A illustrates an example in which an object is not transformed and is placed on a background image. FIG. 20B illustrates an example in which the object in FIG. 20A is transformed and is placed on the background image. In the examples in FIGS. 20A and 20B, the degree-of-importance map is visually expressed in a background image I-4 by using the contour lines. The contour lines show that a region A_{L} having a low degree of importance is disposed at the top left portion of the background image I-4, while a region A_{H} having a high degree of importance is disposed at the bottom right portion of the background image I-4. Objects O-5a and O-5b respectively shown in FIGS. 20A and 20B are rectangular image objects containing text “ABCDE”.

In the example in FIG. 20A, as discussed with reference to FIGS. 15A through 15C, the object O-5a is placed at a position where the degree of importance of the background image I-4 on which the object O-5a is superimposed becomes the lowest. In the example in FIG. 20B, the object O-5b is transformed to have the largest size to such a degree not to exceed the region indicated by the third contour line (indicated by the thick line in FIG. 20B) counted from the region A_{L}. Since the object O-5a is transformed into the object O-5b, the angle of the object O-5b is different from that of the object O-5a and is tilted.

The placement of an object with transformation, such as that in FIG. 20B, may be performed by placing the original size of the object, such as that in FIG. 20A, on a background image according to the procedure discussed with reference to FIGS. 15A through 15C and then by transforming the object. Alternatively, the placement of an object with transformation may be performed without following the procedure discussed with reference to FIGS. 15A through 15C, that is, the object may be placed by searching for the placement position of the object within a region specified by the degree-of-importance map while the object is being transformed to have the largest size. The above-described specific value of the degree of importance for specifying the region where the object is placed may be automatically set in accordance with a predetermined rule or in response to an instruction from a user. An example of the predetermined rule is that the largest value of the degrees of importance of the background image on which the object of the original size and shape is superimposed is used as the specific value.

Another example of an object that can be transformed is a textbox to be placed on a background image. A textbox may be regarded as one type of rectangular object whose size and ratio of the length and the width can be changed. To determine the placement position of a textbox, a region of the degree-of-importance map where the degree of importance of each small region is lower than or equal to a predetermined value may be specified, and the textbox may be placed within this specified region so as to satisfy a specific condition. Examples of the specific condition are that the textbox is transformed to have the largest size within the specified region and that the four vertices of the textbox are positioned on the outer periphery of the specified region.

### (Processing for Controlling Placement Position of Object)

In the exemplary embodiment, by using the degree-of-importance map of a background image, an object is placed basically at a position at which the degree of importance of the background image is low. Depending on the design concept, however, there may be a case in which it is desirable to place an object to stand out in a background image regardless of the content of the background image. In this case, the weighting factor for the degree-of-importance map of the background image and that for the degree-of-importance map of the region setting frame for setting the placement region of the object are adjusted, so that the placement position of the object can be controlled.

As explained with reference to FIGS. 13A through 14, the integrated degree-of-importance map Eₜₒₜₐₗ is generated by combining the degree-of-importance map E_{img} of the background image and the degree-of-importance map E_{frm} of the region setting frame. The value of the degree of importance of each small region in the integrated degree-of-importance map Eₜₒₜₐₗ is calculated by the above-described equation (10). If the value of a is set to be greater than 0.5, the influence of the distribution of the degrees of importance in the degree-of-importance map E_{img} of the background image on the placement position of the object is increased. If the value of a is set to be smaller than 0.5, the influence of the distribution of the degrees of importance in the degree-of-importance map E_{frm} of the region setting frame on the placement position of the object is increased.

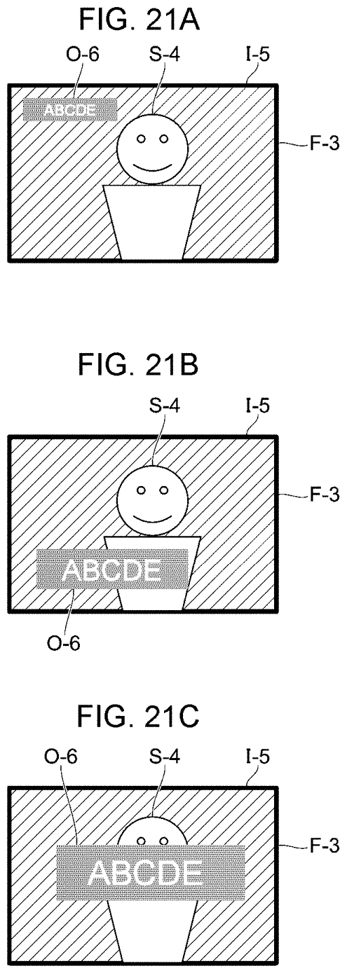

FIGS. 21A through 21C illustrate the relationship of the placement position of an object to the weighting factor set for the degree-of-importance map of a background image and that for the degree-of-importance map of a region setting frame. FIG. 21A illustrates the placement position of an object when the weighting factor for the degree-of-importance map of a background image is greater than that for the degree-of-importance map of a region setting frame. FIG. 21B illustrates the placement position of an object when the weighting factor for the degree-of-importance map of a background image and that for the degree-of-importance map of a region setting frame are substantially the same. FIG. 21C illustrates the placement position of an object when the weighting factor for the degree-of-importance map of a region setting frame is greater than that for the degree-of-importance map of a background image. In the example in FIGS. 21A through 21C, the size of an object O-6 is changed in accordance with the placement position of the object O-6, and also, a region setting frame F-3 is set to determine the entirety of the background image I-5 to be the placement region.

In the example in FIG. 21A, since the weighting factor for the degree-of-importance map E_{img} of the background image I-5 is greater than that for the degree-of-importance map E_{frm} of the region setting frame F-3, the placement position of the object O-6 is greatly influenced by the distribution of the degrees of importance in the degree-of-importance map E_{img} of the background image I-5. Hence, the object O-6 is placed at a position (top left corner in FIG. 21A) where it does not overlap a subject S-4 having a high degree of importance in the degree-of-importance map E_{img}.

In the example in FIG. 21B, since the weighting factor for the degree-of-importance map E_{img} of the background image I-5 and that for the degree-of-importance map E_{frm} of the region setting frame F-3 are substantially the same, the placement position of the object O-6 is influenced by both of the distribution of the degrees of importance in the degree-of-importance map E_{img} of the background image I-5 and that in the degree-of-importance map E_{frm} of the region setting frame F-3. Hence, the object O-6 overlaps the subject S-4 having a high degree of importance in the degree-of-importance map E_{img}, and yet, the object O-6 is placed at a position (bottom left in FIG. 21B) where it does not overlap the face of the subject S-4 particularly having a high degree of importance in the degree-of-importance map E_{img}.

In the example in FIG. 21C, since the weighting factor for the degree-of-importance map E_{frm} of the region setting frame F-3 is greater than that for the degree-of-importance map E_{img} of the background image I-5, the placement position of the object O-6 is greatly influenced by the distribution of the degrees of importance in the degree-of-importance map E_{frm} of the region setting frame F-3. Hence, the object O-6 is placed at the center of the area inside the region setting frame F-3 even though it overlaps the subject S-4 having a high degree of importance in the degree-of-importance map E_{img}.

### (Sequential Placement of Plural Objects)

When plural objects are to be placed on a background image, the degree-of-importance map may be updated while the objects are sequentially placed on the background image. In a specific example, the image processing apparatus 100 generates a degree-of-importance map of a background image on which no object is placed, and then places one object based on this degree-of-importance map. Then, the image processing apparatus 100 generates another degree-of-importance map of the background image on which this object is placed and places another object based on this degree-of-importance map. Thereafter, every time the image processing apparatus 100 places an object, it creates a degree-of-importance map of the background image on which this object is placed and then searches for the placement position of another object based on this degree-of-importance map.

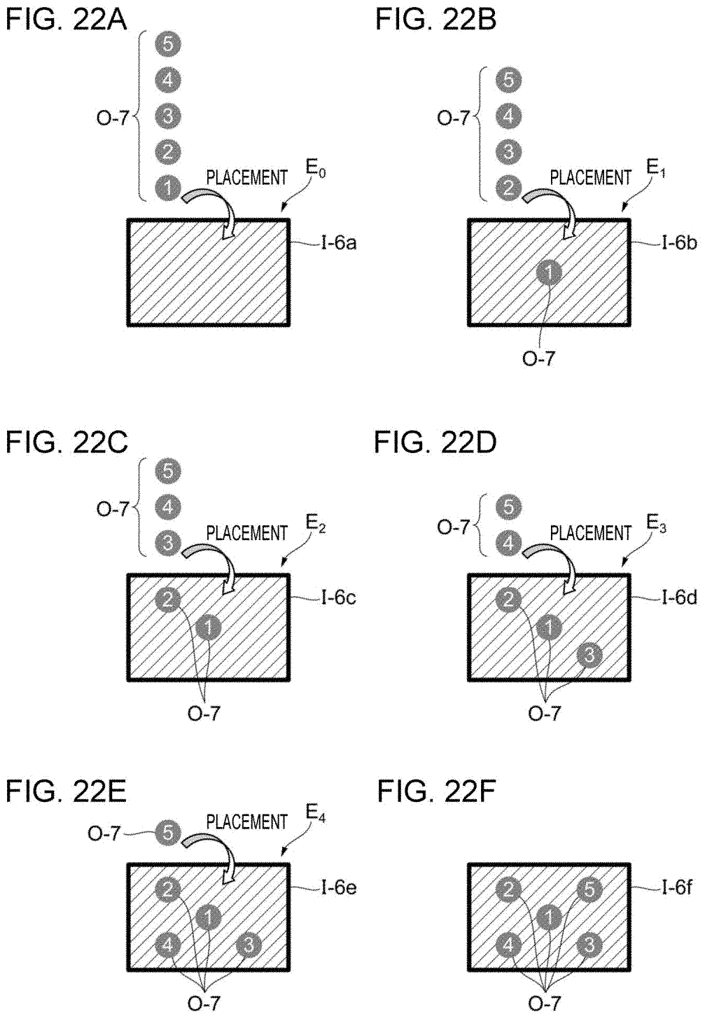

FIGS. 22A through 22F illustrate an example in which multiple objects are sequentially placed on a background image. FIG. 22A illustrates that the first object is being placed on a background image on which no object is placed. FIG. 22B illustrates that the second object is being placed on the background image on which the first object is placed. FIG. 22C illustrates that the third object is being placed on the background image on which the first and second objects are placed. FIG. 22D illustrates that the fourth object is being placed on the background image on which the first through third objects are placed. FIG. 22E illustrates that the fifth object is being placed on the background image on which the first through fourth objects are placed. FIG. 22F illustrates that five objects are all placed on the background image.

In the example in FIG. 22A, since no object O-7 is placed on a background image I-6a, an integrated degree-of-importance map E₀ generated by integrating the degree-of-importance map of the background image I-6a and that of a region setting frame is used as the degree-of-importance map. Based on the distribution of the degrees of importance in this integrated degree-of-importance map E₀, the placement position of the first object O-7 (object appended with the number “1” in FIG. 22A) is determined.

In the example in FIG. 22B, one object O-7 is placed on a background image I-6b by the above-described processing, and thus, an integrated degree-of-importance map E₁ generated by integrating the degree-of-importance map of the background image I-6b and that of the region setting frame is used as the degree-of-importance map. Based on the distribution of the degrees of importance in this integrated degree-of-importance map E₁, the placement position of the second object O-7 (object appended with the number “2” in FIG. 22B) is determined.

In the example in FIG. 22C, two objects O-7 are placed on a background image I-6c by the above-described processing, and thus, an integrated degree-of-importance map E₂ generated by integrating the degree-of-importance map of the background image I-6c and that of the region setting frame is used as the degree-of-importance map. Based on the distribution of the degrees of importance in this integrated degree-of-importance map E₂, the placement position of the third object O-7 (object appended with the number “3” in FIG. 22C) is determined.

In the example in FIG. 22D, three objects O-7 are placed on a background image I-6d by the above-described processing, and thus, an integrated degree-of-importance map E₃ generated by integrating the degree-of-importance map of the background image I-6d and that of the region setting frame is used as the degree-of-importance map. Based on the distribution of the degrees of importance in this integrated degree-of-importance map E₃, the placement position of the fourth object O-7 (object appended with the number “4” in FIG. 22D) is determined.

In the example in FIG. 22E, four objects O-7 are placed on a background image I-6e by the above-described processing, and thus, an integrated degree-of-importance map E₄ generated by integrating the degree-of-importance map of the background image I-6e and that of the region setting frame is used as the degree-of-importance map. Based on the distribution of the degrees of importance in this integrated degree-of-importance map E₄, the placement position of the fifth object O-7 (object appended with the number “5” in FIG. 22E) is determined.

In FIG. 22F, five objects O-7 are placed on a background image I-6f by the above-described processing. All the objects O-7 are placed and processing is thus completed.

### (Adjustment of Background Image)

In the placement of an object on a background image, there may be a case in which it is desirable to fix the position of the object in a placement region. In this case, the size of the background image or the position of the background image with respect to the region setting frame may be adjusted so that the object can be placed by avoiding a region of the background image having a high degree of importance. The placement position determiner 150 of the image processing apparatus 100, for example, searches for the placement position of the object on the background image while changing the position of the background image with respect to the region setting frame.

If the size of the region setting frame is the same as the initial size of the background image, the region setting frame extends to outside the background image if the background image is shifted. In this case, the background image may be enlarged, and then, the position of the background image with respect to the region setting frame and to the object may be adjusted. Adjusting of the position of the background image may include rotating of the background image. A certain limitation may be imposed on changing of the size and/or the position of the background image. An example of the limitation is that a subject having a certain value of degree of importance or higher in the background image does not extend to outside the region setting frame. Another example of the limitation is that the size of the background image does not become smaller than the region setting frame.

### (Application of Degree-of-Importance Map to Reviewing of Composition of Image)

In the exemplary embodiment, the degree-of-importance map is used for determining the placement position of an object on an image. The degree-of-importance map may be used for reviewing the composition of an image. The positions and the arrangement of subjects having a high degree of importance in an image are reflected in the distribution of the degrees of importance in the degree-of-importance map of the image. Hence, the composition of the image can be reviewed based on the distribution of the degrees of importance in the degree-of-importance map. Additionally, a trimming frame may be set on a target image so that the degrees of importance in the degree-of-importance map represent a certain composition, and then, the image having this composition may be cropped from the target image. The placement position adjuster 160 of the image processing apparatus 100, for example, adjusts the position of a trimming frame which is set to assume a certain composition.

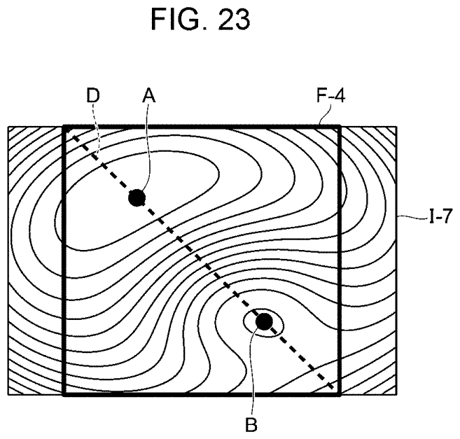

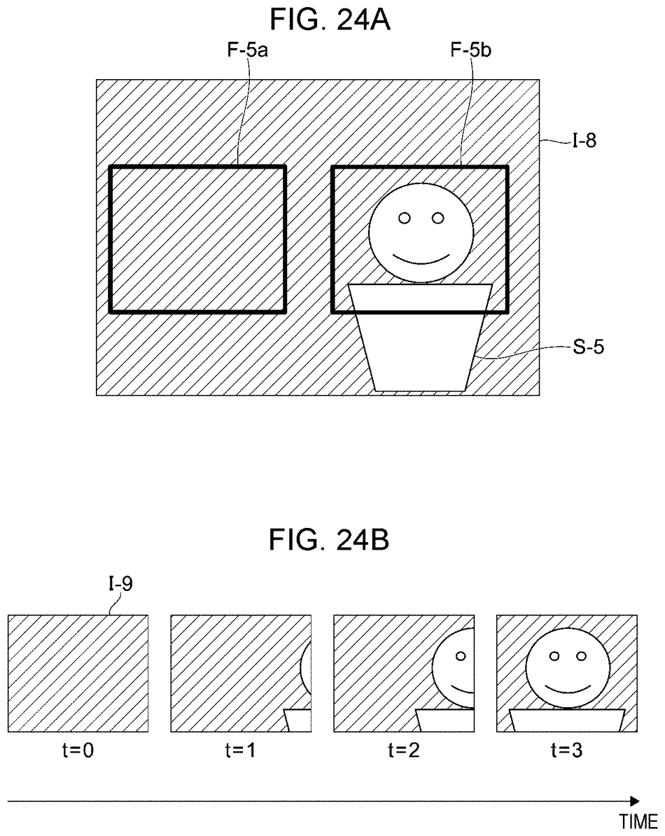

FIG. 23 illustrates an example of the composition of an image specified based on the degree-of-importance map. In an image I-7 shown in FIG. 23, the degree-of-importance map is expressed by the contour lines. The degree-of-importance map shows that the image I-7 has two positions, position A and position B, at which the value of the degree of importance takes an extreme value. The extreme value may be either one of a maximal value having the highest degree of importance and a minimal value having the lowest degree of importance.

A trimming frame F-4 is set in the image I-7 in FIG. 23. It is now assumed that the trimming frame F-4 is set so that an image to be cropped by trimming forms a composition in which major subjects are arranged on a diagonal line on the screen. In the example in FIG. 23, position A and position B on the degree-of-importance map are placed on a diagonal line D of the trimming frame F-4. It is assumed that X-Y coordinates using the top left corner as the origin are set in the image I-7 and that the coordinate values at position A in the image I-7 are represented by (x_{A}, y_{A}) and the coordinate values at position B in the image I-7 are represented by (x_{B}, y_{B}). The range of the Y coordinate of the image I-7 is y=0 to 1. The vertex v1 at the top left corner of the trimming frame F-4 on the diagonal line D and the vertex v2 at the bottom right corner of the trimming frame F-4 on the diagonal line D are expressed by the following equations (12).

$$v 1 = ( \frac{{x}_{A} {y}_{B} - {x}_{B} {y}_{A}}{{x}_{A} - {x}_{B}} , 0 ) \qquad ( 12 )$$

$$v 2 = ( \frac{{x}_{B} {y}_{A} - {x}_{A} {y}_{B} + 1}{{y}_{A} - {y}_{B}} , 1 )$$

The trimming frame F-4 is placed so that the vertices v1 and v2 are located at the positions expressed by equations (12). Then, the image to be cropped by the trimming frame F-4 forms the following composition: position A and position B at which the degree of importance in the degree-of-importance map of the image I-7 takes an extreme value are located on a diagonal line on the screen.

### (Application of Degree-of-Importance Map to Video Image)

If the position of an object is shifted on an image with the lapse of time, video images can be created. The degree-of-importance map may be used for setting a motion path of the object. On the degree-of-importance map, a flow path for shifting the object is set based on the distribution of the degrees of importance. Then, the object is shifted along the flow path, thereby creating video images. As the flow path to be set on the degree-of-importance map, a path extending from a position at the lowest degree of importance to a position at the highest degree of importance (or vice versa) and having the smallest slope or the largest slope of the degree of importance may be used.

FIGS. 24A and 24B illustrate an approach to creating video images by moving a trimming frame along a flow path on a degree-of-importance map. FIG. 24A illustrates the movement of the trimming frame. FIG. 24B illustrates created video images.

In a target image I-8 shown in FIG. 24A, a subject S-5, which is the figure of a person, is displayed on the right side of the screen. A region, which occupies about the lower two thirds of the right half of the screen where the subject S-5 is displayed, is a region where the degree of importance in the degree-of-importance map (not shown) is high. A region, which is about the left half without the subject S-5, and a region, which occupies about the upper one third, are background regions where the degree of importance in the degree-of-importance map is low. It is assumed that when a trimming frame F-5 is located at a position F-5a of the target image I-8 in FIG. 24A, the inter-frame degree of importance of the region surrounded by the trimming frame F-5 is the lowest. It is also assumed that when the trimming frame F-5 is located at a position F-5b of the target image I-8 in FIG. 24A, the inter-frame degree of importance of the region surrounded by the trimming frame F-5 is the highest.

In the example in FIG. 24A, the image processing apparatus 100 linearly moves the trimming frame F-5 from the position F-5a to the position F-5b of the target image I-8 along the flow path which is set based on the distribution of the degrees of importance in the degree-of-importance map. In other words, the trimming frame F-5 is moved from a region where the degree of importance is low to a region where the degree of importance is high. As a result of sequentially executing trimming processing while moving the trimming frame F-5, the image processing apparatus 100 creates sequential images I-9, which serve as video frames, as shown in FIG. 24B.

In the example in FIG. 24B, the images I-9 obtained by shifting the trimming frame F-5 are arranged in chronological order. In FIG. 24B, the images I-9 at individual time points t=0, t=1, t=2, and t=3 are shown. When t=0, the trimming frame F-5 is located at the position F-5a in FIG. 24A. When t=3, the trimming frame F-5 is located at the position F-5b in FIG. 24A. The images I-9 obtained by trimming processing are changed in the following manner over time: when t=0, only the background region of the target image I-8 is displayed in an image I-9; when t=1, as a result of shifting the trimming frame F-5, part of the subject S-5 of the target image I-8 is displayed near the right edge of the image I-9; when t=2, as a result of shifting the trimming frame F-5, about half of the face of the subject S-5 of the target image I-8 is displayed on the right side of the image I-9; and when t=3, as a result of shifting the trimming frame F-5, the entire face of the subject S-5 is displayed at the center of the image I-9. As a result of sequentially displaying the images I-9 over time from t=0 to t=3, the images I-9 can be displayed as video images starting from the background of the target image I-8 and then showing the subject S-5 gradually appearing from the right side to the center of the screen.

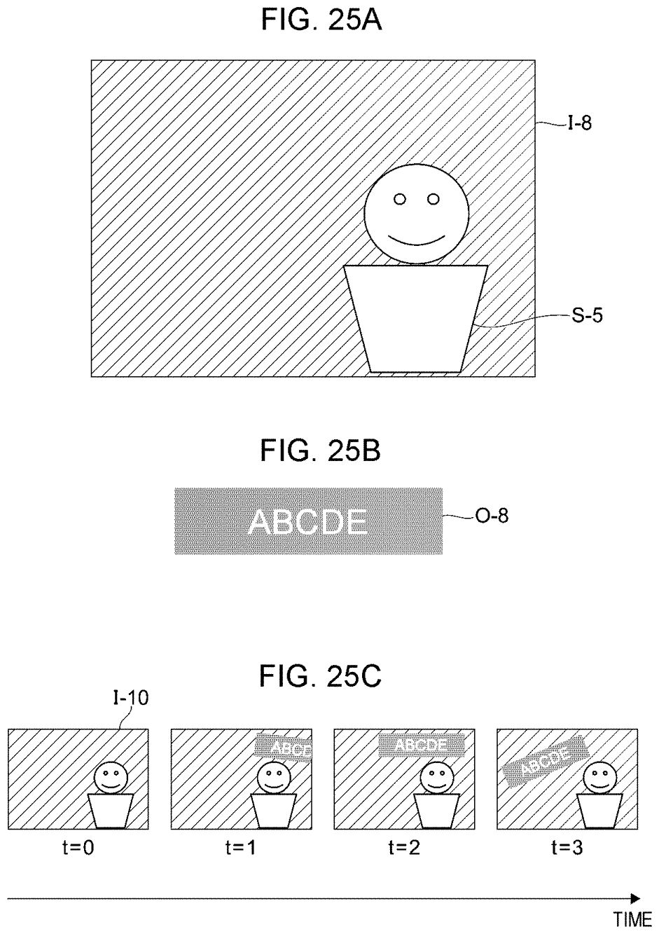

FIGS. 25A through 25C illustrate an approach to creating video images by moving an image object along a flow path set on a degree-of-importance map. FIG. 25A illustrates an example of a background image. FIG. 25B illustrates an example of an image object. FIG. 25C illustrates created video images.

A background image I-8 shown in FIG. 25A is similar to the target image I-8 shown in FIG. 24A. A region, which occupies about the lower two thirds of the right half of the screen where the subject S-5 is displayed, is a region where the degree of importance in the degree-of-importance map (not shown) is high. A region, which is about the left half without the subject S-5, and a region, which occupies about the upper one third, are regions where the degree of importance in the degree-of-importance map is low. The top region above the subject S-5 is closer to the subject S-5 than the left half region is, and the degree of importance of the top region is higher than that of the left-half region.

An image object O-8 shown in FIG. 25B is a rectangular image object containing text “ABCDE”. The image processing apparatus 100 moves the image object O-8 along a flow path which is set based on the distribution of the degrees of importance in the degree-of-importance map, so that the object O-8 starts from the outside of the right side of the background image I-8, enters the right side of the background image I-8, and reaches the left-half region where the degree of importance is low. In other words, the image object O-8 shifts to a region where the degree of importance is lower. The image object O-8 starts moving from the outside of the background image I-8, passes above the subject S-5 having a high degree of importance so as to bypass the region where the subject S-5 is displayed, and reaches the left-side region. As a result of sequentially creating screenshots of the background image I-8 while moving the image object O-8, the image processing apparatus 100 can obtain sequential images I-10, which serve as video frames, as shown in FIG. 25C.

In the example in FIG. 25C, the images I-10 generated by shifting the image object O-8 are arranged in chronological order. In FIG. 25C, the images I-10 at individual time points t=0, t=1, t=2, and t=3 are shown. The images I-10 are changed in the following manner over time: when t=0, only the background image I-8 without the image object O-8 is displayed in the image I-10; when t=1, the image object O-8 enters the background image I-8 from the right side and part of the image object O-8 is displayed; when t=2, as a result of shifting the image object O-8 further, the entirety of the image object O-8 is displayed above the subject S-5; and when t=3, as a result of shifting the image object O-8 even further, the image object O-8 reaches the left side of the subject S-5 where the degree of importance is low. As a result of sequentially displaying the images I-10 over time from t=0 to t=3, the images I-10 can be displayed as video images so that the background image I-8 without the image object O-8 is first shown, and then, the image object O-8 enters the background image I-8 from the right side, passes over the subject S-5, and then reaches the left side of the screen.

### (Shape of Region Setting Frame)

As discussed above, when placing an object on a background image, the image processing apparatus 100 sets a region setting frame and determines the region of the background image surrounded by the region setting frame to be a placement region where the object can be placed. The region setting frame may be the same size and the same shape as a background image, or it may be of a size to set part of the background image to be the placement region. The shape of the region setting frame is not restricted to a rectangle.

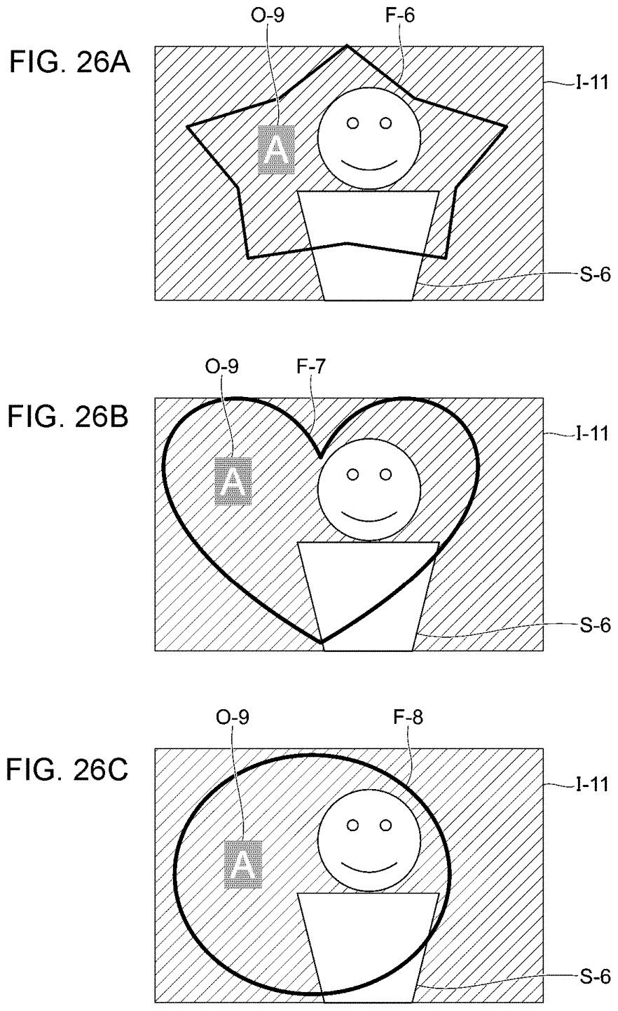

FIGS. 26A through 26C illustrate examples of the shape of the region setting frame. FIG. 26A illustrates an example of a star-shaped region setting frame. FIG. 26B illustrates an example of a heart-shaped region setting frame. FIG. 26C illustrates an example of a circular region setting frame. In the example in FIG. 26A, a subject S-6 is displayed in a background image I-11 and a star-shaped region setting frame F-6 is set by including part of the subject S-6. A degree-of-importance map is created for the placement region surrounded by the region setting frame F-6. Although the degree-of-importance map is not shown, it represents that the degree of importance of the subject S-6 and that of the region setting frame F-6 are high, while that of a blank region separated from the subject S-6 or the region setting frame F-6 is low. Based on the distribution of the degrees of importance in the degree-of-importance map, an image object O-9 is placed at a position at which the degree of importance is low.

In the example in FIG. 26B, a subject S-6 is displayed in a background image I-11 and a heart-shaped region setting frame F-7 is set by including part of the subject S-6. A degree-of-importance map is created for the placement region surrounded by the region setting frame F-7. Although the degree-of-importance map is not shown, it represents that the degree of importance of the subject S-6 and that of the region setting frame F-7 are high, while that of a blank region separated from the subject S-6 or the region setting frame F-7 is low. Based on the distribution of the degrees of importance in the degree-of-importance map, an image object O-9 is placed at a position at which the degree of importance is low.

In the example in FIG. 26C, a subject S-6 is displayed in a background image I-11 and a circular region setting frame F-8 is set by including part of the subject S-6. A degree-of-importance map is created for the placement region surrounded by the region setting frame F-8. Although the degree-of-importance map is not shown, it represents that the degree of importance of the subject S-6 and that of the region setting frame F-8 are high, while that of a blank region separated from the subject S-6 or the region setting frame F-8 is low. Based on the distribution of the degrees of importance in the degree-of-importance map, an image object O-9 is placed at a position at which the degree of importance is low.

As described above, in the exemplary embodiment, a degree-of-importance map is created for the placement region surrounded by a region setting frame. The placement position of an object is searched for and determined based on the distribution of the degrees of importance in this degree-of-importance map. Hence, regardless of the shape of a region setting frame, the placement position of an object can be determined in a similar manner.

### (Visualization of Degree-of-Importance Map)

The degree-of-importance map generated in the exemplary embodiment is information representing a distribution of the degrees of importance and is used for searching for the placement position of an object on an image, and thus, it is not necessarily displayed. However, the degree-of-importance map may be visually expressed and be displayed together with an image to be processed, so that the distribution of the degrees of importance can be presented to a user as information on the design of the image to be processed. An image having a degree-of-importance map superimposed thereon may be displayed on a display device by the output unit 180 of the image processing apparatus 100, for example.

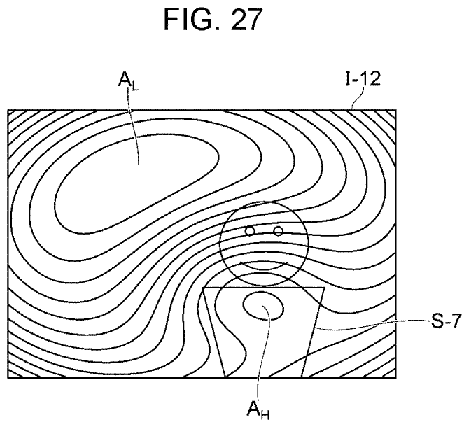

FIG. 27 illustrates a display example of a degree-of-importance map. In the example in FIG. 27, a subject S-7 is displayed in an image I-12. A degree-of-importance map is superimposed on the image I-12 and is displayed. There is no limitation on the manner in which the degree-of-importance map is displayed if the distribution of the degrees of importance is visually expressed. In a specific example, based on the values of the degrees of importance of individual small regions forming the degree-of-importance map, the positional relationship between small regions whose degree of importance is the same or whose difference in the degree of importance is smaller than a certain difference range is visually expressed. In another specific example, a region having a higher degree of importance than a surrounding region and a region having a lower degree of importance than a surrounding region may be expressed so that they can be visually identified.

In the example in FIG. 27, the distribution of the degrees of importance in a degree-of-importance map is visually expressed by using the contour lines. In the image I-12 shown in FIG. 27, the contour lines show that a region A_{H} having a high degree of importance is disposed at the bottom right portion of the screen where the subject S-7 is displayed, while a region A_{L} having a low degree of importance is disposed at the top left portion of the screen. As described above, the degree-of-importance map may be represented in any manner if the distribution of the degrees of importance is visually expressed. Instead of using contour lines such as those in FIG. 27, the distribution of the degrees of importance may be expressed by different colors or grayscale in accordance with the values of the degrees of importance.

As discussed in the exemplary embodiment, in the placement of an object on an image to be processed, a degree-of-importance map may be recreated and displayed after the object is placed on the image. Then, the distribution of the degrees of importance after the object is placed and/or how the distribution of the degrees of importance is changed before and after the object is placed may be used as a material for reviewing the design regarding the placement of the object.

### (Reviewing of Text Display in Object)

In the placement of an object including text on a background image, it may be selected whether the text is displayed in a vertical writing direction or a horizontal writing direction. In this case, by using a degree-of-importance map, the lowest value of the target degree of importance when the object including the vertically written text is displayed on the background image and that when the object including the horizontally written text is displayed on the background image may be compared with each other. The placement position determiner 150 of the image processing apparatus 100, for example, compares the lowest values of the target degrees of importance and selects the display direction of the object.

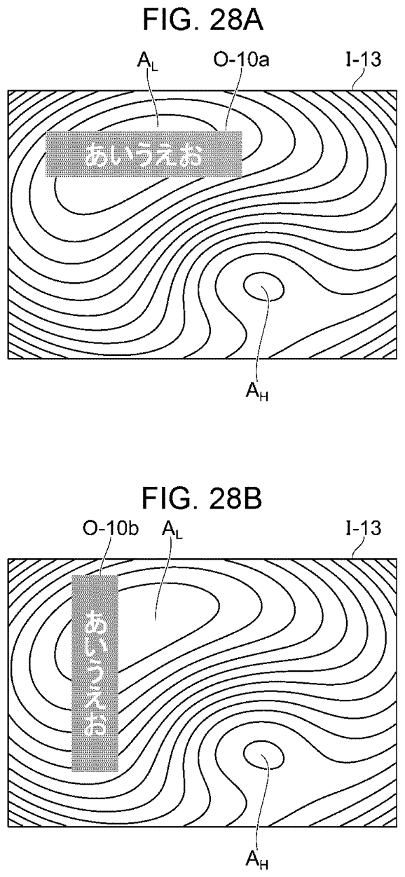

FIGS. 28A and 28B illustrate examples of an image on which an object including text is placed. FIG. 28A illustrates an example in which an image object including horizontal written text is placed. FIG. 28B illustrates an example in which an image object including vertical written text is placed. In the example in FIG. 28A, an image object O-10a including horizontal written text is placed on a background image I-13. In FIG. 28A, the contour lines representing a degree-of-importance map are indicated in the background image I-13 and show that there are a region A_{H} having a high degree of importance and a region A_{L} having a low degree of importance. As discussed with reference to FIGS. 15A through 15C, the image object O-10a is placed at a position where the target degree of importance of the region of the background image I-13 on which the image object O-10a is superimposed takes the lowest value. In the example in FIG. 28B, an image object O-10b including vertical written text is placed on a background image I-13. The background image I-13 in FIG. 28B is similar to that in FIG. 28A. The image object O-10b is placed at a position where the target degree of importance of the region of the background image I-13 on which the image object O-10b is superimposed takes the lowest value.

The target degree of importance at the placement position of the image object O-10a in FIG. 28A and that of the image object O-10b in FIG. 28B may be compared with each other, and the image object having a lower target degree of importance may be selected as the object to be placed on the background image I-13. For example, if the target degree of importance at the placement position of the image object O-10a is lower than that of the image object O-10b, the image object O-10a is selected as the object to be placed on the background image I-13. In this manner, when it is necessary to select which one of multiple objects to be placed on an image, the target degrees of importance at the placement positions of the individual objects are compared with each other by using a degree-of-importance map, so that the object to be placed on the background image can be quantitatively determined.

### (Layout of Plural Images)

As in photos being placed on an album, there may be a case in which multiple images are placed in a template region having a fixed layout in accordance with this layout. The images are trimmed to be adjusted to plural display frames disposed in the fixed layout and are displayed in the corresponding display frames. Allocating of the images to the plural display frames is thus necessary and may be performed based on a degree-of-importance map. Trimming frames are used for trimming the images to be adjusted to the display frames. The placement position determiner 150 of the image processing apparatus 100, for example, places the trimming frames and also compare the inter-frame degrees of importance and allocates the images to the display frames based on the comparison results, which will be discussed later.

The approach to allocating the images to the display frames will be explained below. Numbers 1, . . . , M are given to M images, and numbers 1, . . . , F are given to F display frames disposed in a template region. It is assumed that fᵢ (i=1, . . . , M) represents the number 1, . . . , F of the display frame allocated to the i-th image. When the i-th image is trimmed to be adjusted to the fᵢ-th display frame, the maximum value of the inter-frame degree of importance of the region surrounded by the trimming frame is indicated by gᵢ(fᵢ) and is called the maximum inter-frame degree of importance. The shape of the trimming frame is the same as the fᵢ-th display frame. The X-direction coordinate value k of the trimming frame corresponding to the fᵢ-th display frame is set to be 0 to W^{fi}_{frm}-1, while the Y-direction coordinate value m of the trimming frame corresponding to the fᵢ-th display frame is set to be 0 to H^{fi}_{frm}-1. The maximum inter-frame degree of importance gᵢ(fᵢ) is the maximum total value of the degrees of importance within a frame when the degree-of-importance map Eᵢ of the i-th image is placed in the fᵢ-th display frame and is calculated by the following equation (13).

$${ℊ}_{i} ( {f}_{i} ) = {{max}_{0 \leq {x}_{i} \leq {W}_{img}^{i} - {W}_{frm}^{{f}_{i}}}}_{0 \leq {y}_{i} \leq {H}_{img}^{i} - {H}_{frm}^{{f}_{i}}} {\sum }_{k = 0}^{{W}_{frm}^{{f}_{i}} - 1} {\sum }_{m = 0}^{{H}_{frm}^{{f}_{i}} - 1} {E}_{i} ( {x}_{i} + k , {y}_{i} + m ) \qquad ( 13 )$$

The total value of the maximum inter-frame degrees of importance gᵢ(fᵢ) obtained by combining the allocated images and display frames is represented by G(f₁, . . . f_{M}). The number of display frame allocated to the j-th image is indicated by fⱼ, and a set of combinations of f₁, . . . f_{M} that satisfy the conditions 0≤fᵢ≤M and fᵢ≠fⱼ (i≠j, 0≤i, j≤M) is represented by S. Then, (f₁, . . . f_{M})∈S that maximizes G(f₁, . . . f_{M}) is found by the following equation (14).

$${arg min}_{( {f}_{1} , … , {f}_{M} ) ∈ S} G ( {f}_{1} , … , {f}_{M} ) = {arg min}_{( {f}_{1} , … , {f}_{M} ) ∈ S} {\sum }_{i = 1}^{M} {ℊ}_{i} ( {f}_{i} ) \qquad ( 14 )$$

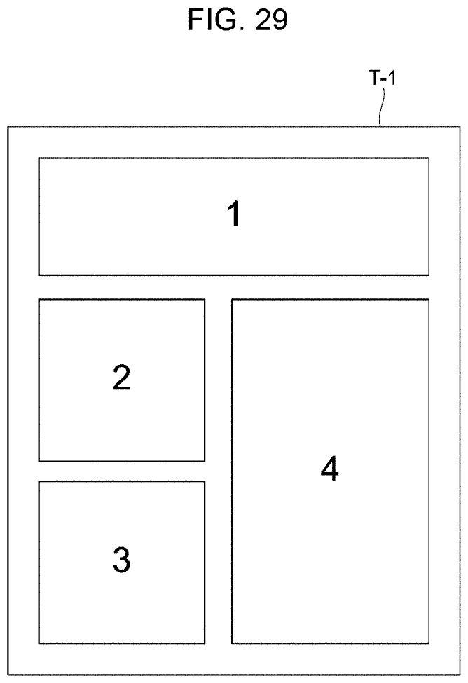

FIG. 29 illustrates an example of a template region. Four display frames are disposed in a template region T-1 shown in FIG. 29. In the example in FIG. 29, numbers 1 to 4 are given to the display frames, and numerical values “1” through “4” corresponding to the numbers given to the display frames are shown. Hereinafter, when the display frames are distinguished from each other, they are called the first through fourth display frames using the given numbers. The shape and size of each display frame and the position in the template region T-1 are fixed.

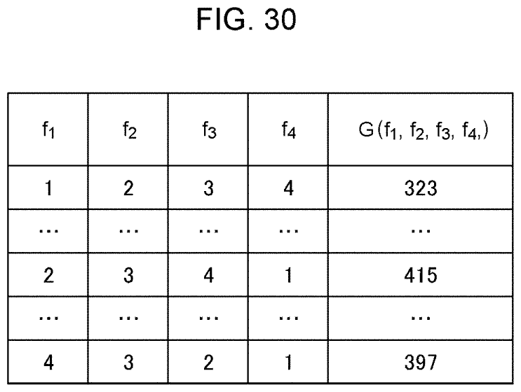

FIG. 30 illustrates the relationship of a combination of images and display frames in a template region to the total value of the maximum inter-frame degrees of importance. Regarding the combinations of f₁-th through f₄-th display frames and first through fourth images, the total value G(f₁, f₂, f₃, f₄) of the maximum inter-frame degrees of importance is calculated in accordance with each combination of images and display frames, and the calculation results are shown in FIG. 30. Only some of the combinations are shown in FIG. 30, and in this example, the possible number of combinations of the display frames and images is 24 since the number of display frames is 4 and the number of images is 4. In this example, the combination of f₁=2, f₂=3, f₃=4, and f₄=1 results in the largest value G(f₁, f₂, f₃, f₄)=415.

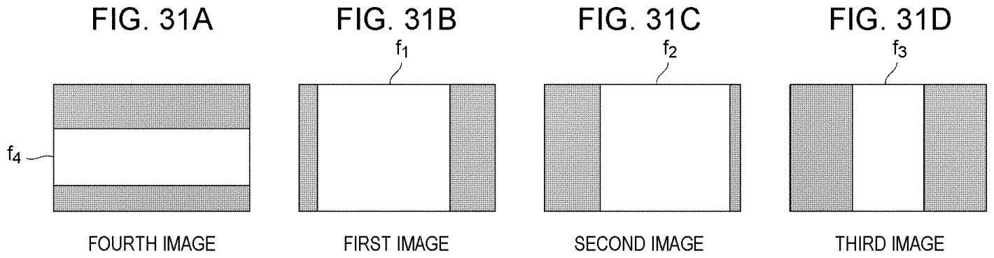

FIGS. 31A through 31D illustrate a combination of display frames and images in which the total value of the maximum inter-frame degrees of importance becomes the largest. FIG. 31A illustrates the f₄-th display frame and the corresponding image. FIG. 31B illustrates the f₁-th display frame and the corresponding image. FIG. 31C illustrates the f₂-th display frame and the corresponding image. FIG. 31D illustrates the f₃-th display frame and the corresponding image.

FIG. 31A shows that the fourth image is trimmed using the trimming frame corresponding to the f₄ (=1)-th display frame and the cropped image is displayed in the first display frame of the template region T-1 shown in FIG. 29. The placement position of the trimming frame in the image in the first display frame is the position at which the inter-frame degree of importance becomes the largest. The maximum inter-frame degree of importance gᵢ(fᵢ) is g₄(1)=75.

FIG. 31B shows that the first image is trimmed using the trimming frame corresponding to the f₁ (=2)-th display frame and the cropped image is displayed in the second display frame of the template region T-1 shown in FIG. 29. The placement position of the trimming frame in the image in the second display frame is the position at which the inter-frame degree of importance becomes the largest. The maximum inter-frame degree of importance gᵢ(fᵢ) is gᵢ(2)=100.

FIG. 31C shows that the second image is trimmed using the trimming frame corresponding to the f₂ (=3)-th display frame and the cropped image is displayed in the third display frame of the template region T-1 shown in FIG. 29. The placement position of the trimming frame in the image in the third display frame is the position at which the inter-frame degree of importance becomes the largest. The maximum inter-frame degree of importance gᵢ(fᵢ) is g₂ (3)=120.

FIG. 31D shows that the third image is trimmed using the trimming frame corresponding to the f₃ (=4)-th display frame and the cropped image is displayed in the fourth display frame of the template region T-1 shown in FIG. 29. The placement position of the trimming frame in the image in the fourth display frame is the position at which the inter-frame degree of importance becomes the largest. The maximum inter-frame degree of importance gᵢ(fᵢ) is g₃(4)=120.

The total value G(fᵢ, f₂, f₃, f₄) of the maximum inter-frame degrees of importance is calculated as follows.

G(f₁=2,f₂=3,f₃=4,f₄=1)=g₁(2)+g₂(3)+g₃(4)+g₄(1)=100+120+120+75=415

As a result, G(f₁, f₂, f₃, f₄)=415 are obtained, as shown in FIG. 30.

In the example of the allocation of images to display frames discussed with reference to FIGS. 29 through 31D, the number of images and that of the display frames in a template region are the same (M=F). The above-described processing for placing multiple images in a fixed layout is also applicable to when the number of images is greater than that of display frames (M>F). In this case, too, the total value G of the maximum inter-frame degrees of importance gᵢ(fᵢ) is calculated for each combination of images and display frames, and the combination for which the largest total value G is obtained is determined.

When the number of display frames is greater than that of images (M<F), “0”, which means “unused”, is added to fᵢ representing the display frame to which the i-th image is allocated, and the maximum inter-frame degree of importance gᵢ(fᵢ) and the total value G are calculated. In this case, when fᵢ=0, the total value G is calculated by setting gᵢ(fᵢ)=0, and fᵢ=f₁=0 (i≠j) holds true.

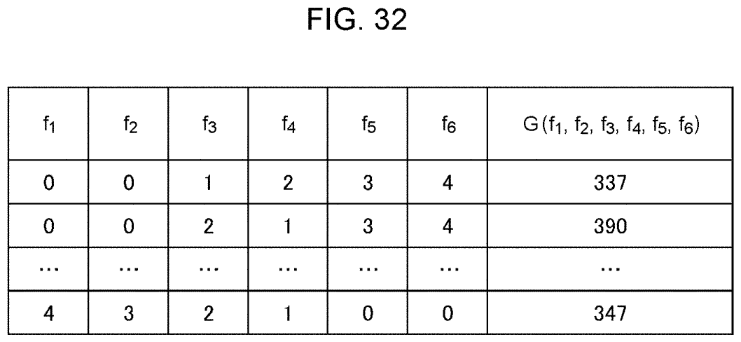

FIG. 32 illustrates the relationship of a combination of images and display frames in a template region to the total value of the maximum inter-frame degrees of importance when the number of display frames is greater than that of images. In the example in FIG. 32, the number of images is 4 and that of display frames is 6. Accordingly, “0” (unused) is input for two display frames in each combination of images and display frames.

The exemplary embodiment of the disclosure has been discussed above, but the technical scope of the disclosure is not restricted to this exemplary embodiment. For example, in the above-described exemplary embodiment, a top-down saliency map and a bottom-up saliency map are created and are integrated with each other. Then, a degree-of-importance map is created from the integrated saliency map. Alternatively, a degree-of-importance map is created from a top-down saliency map, and another degree-of-importance map is created from a bottom-up saliency map. Then, the two degree-of-importance maps are combined with each other. However, depending on an image to be processed or the content of an object to be placed, only one of a top-down saliency map and a bottom-up saliency map may be used, and a degree-of-importance map may be created based on this saliency map. Various modifications may be made and alternatives may be used without departing from the spirit and scope of the disclosure and such modifications and alternatives are encompassed in the disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing apparatus comprising:
a processor configured to:
display an image on a display device;
calculate, for each of small regions set in the image, a degree of importance based on characteristics of the image; and
display a degree-of-importance map on the display device in such a manner that the degree-of-importance map is superimposed on a subject region of the image, the degree-of-importance map visually representing a relative relationship between the degrees of importance of the small regions.

2. The image processing apparatus according to claim 1, wherein the degree-of-importance map visually expresses a positional relationship between the small regions whose degree of importance is identical or whose difference in the degree of importance is smaller than a certain difference range.

3. The image processing apparatus according to claim 2, wherein the degree-of-importance map visually expresses a first region having a higher degree of importance than a surrounding region and a second region having a lower degree of importance than a surrounding region so that the first and second regions are visually identifiable.

4. The image processing apparatus according to claim 1, wherein the processor is configured to use saliency as the characteristics of the image for calculating the degree of importance and to determine the degree of importance of each one of the small regions set in the subject region of the image by reflecting an influence of the saliency of another one of the small regions set in the subject region of the image.

5. The image processing apparatus according to claim 4, wherein the processor is configured to use a function for calculating the degree of importance of each one of the small regions so as to reflect the influence of the saliency of another one of the small regions, the function being a function in which, as a distance between each one of the small regions and another one of the small regions is longer, the influence of the saliency of the another one of the small regions is attenuated to a greater level.

6. A non-transitory computer readable medium storing a program causing a computer to execute a process, the process comprising:
calculating a degree of importance for each one of small regions set in an image, by reflecting an influence of characteristics of another one of the small regions of the image; and
placing an object at a certain placement position on the image, the placement position being determined based on the degree of importance calculated for each one of the small regions.

7. The non-transitory computer readable medium according to claim 6, wherein, in the calculating of the degree of importance, saliency of the image is used as the characteristics, and the degree of importance of each one of the small regions is determined by reflecting the saliency of another one of the small regions.

8. The non-transitory computer readable medium according to claim 7, wherein, in the calculating of the degree of importance, a function is used for calculating the degree of importance of each one of the small regions so as to reflect the influence of the saliency of another one of the small regions, the function being a function in which, as a distance between each one of the small regions and another one of the small regions is longer, the influence of the saliency of the another one of the small regions is attenuated to a greater level.

9. The non-transitory computer readable medium according to claim 6, wherein, in the placing of the object, the placement position of the object on the image is determined in accordance with a type of the object so that a total value of the degrees of importance of the small regions at the placement position of the object satisfies a predetermined condition.

10. The non-transitory computer readable medium according to claim 9, wherein, if the object is an image object or a text object to be placed on the image used as a background, the placement position of the object is determined so that the total value of the degrees of importance of the small regions on which the object is superimposed when the object is placed on the image becomes a smallest value.

11. The non-transitory computer readable medium according to claim 9, wherein, if the object is a frame for specifying an outline of part of the image to be cropped, the placement position of the object is determined so that the total value of the degrees of importance of the small regions which are surrounded by the frame when the object is placed on the image becomes a largest value.

12. The non-transitory computer readable medium according to claim 6, wherein, in the placing of the object, the object is processed and is placed on the image so as to be included in a region where the degree of importance is smaller than or equal to a specific value.

13. The non-transitory computer readable medium according to claim 12, wherein the specific value is determined in accordance with a preset rule based on the degree of importance.

14. The non-transitory computer readable medium according to claim 12, wherein the specific value is specified in response to an instruction from a user.

15. The non-transitory computer readable medium according to claim 12, wherein, in the processing of the object, the object is transformed and is placed on the image so that the object has a largest size within the region where the degree of importance is smaller than or equal to the specific value.

16. The non-transitory computer readable medium according to claim 12, wherein, in the processing of the object, the object is enlarged or reduced and is placed on the image so that the object has a largest size within the region where the degree of importance is smaller than or equal to the specific value.

17. An image processing method comprising:
displaying an image on a display device;
calculating, for each of small regions set in the image, a degree of importance based on characteristics of the image; and
displaying a degree-of-importance map on the display device in such a manner that the degree-of-importance map is superimposed on a subject region of the image, the degree-of-importance map visually representing a relative relationship between the degrees of importance of the small regions.
